(19) United States
(12) Patent Application Publication
(10) Pub. No.: US 2008/0233791 A1
(43) Pub. Date: Sep. 25, 2008

(54) COMPRESSION SNAP ELECTRICAL CONNECTOR

(75) Inventor: Rip HANKS, Gulf Breeze, FL (US)

Correspondence Address: Momkus McCluskey, LLC, 3051 Oak Grove Roade, Suite # 220, Downers Grove, IL, 60515-1181, US

(73) Assignee: Centerpin Technology, Inc., Pensacola, FL (US)

(21) Appl. No.: 12/126,699

(22) Filed: May 23, 2008

Related U.S. Application Data
(63) Continuation-in-part of application No. 11/737,495, filed on Apr. 19, 2007.
Application No. 11/737,495 is a continuation-in-part of application No. 11/420,646, filed on May 26, 2006, now Pat. No. 7,226,308.

(51) Int. Cl. H01R 11/20

(52) U.S. Cl. 439/427

(57) ABSTRACT

One of a set of caps, each having a bore for accepting a conductor within a predetermined range of diameters, has at least one ridge on an external surface thereof formed of a surface pair, with the area of one of the surface pairs being much greater than the other one of the surface pairs. This cap is received into a bore of female connector body with a center pin. The female connector body has one, and preferably has two, grooves formed by a like differential surface pair. A front end of the cap is cut up into fingers which, upon contacting a sloped surface in the female connector body, will fold radially inwardly to clamp the conductor to the center pin.

### RELATED APPLICATIONS

This application is a continuation in part of copending U.S. patent application Ser. No. 11/737,495 filed 19 Apr. 2007, owned by the assignee hereof, which is in turn a continuation in part of U.S. patent application Ser. No. 11/420,646 filed May 26, 2006, now U.S. Pat. No. 7,226,308 B1, owned by the assignee hereof. The disclosure of those applications are fully incorporated herein by reference.

### BACKGROUND OF THE INVENTION

There are many electrical connectors which are known from the published prior art or the marketplace. These connectors seek to connect together electrical conductors without soldering and often without the use of tools. Connectors exist for multistranded insulated wires or cables as well as coaxial cables.

These connectors usually require stripping the insulation off of a terminal portion of the wire, and all are connected together by twisting a cap onto a connector body. But helical twisting motions of a multistranded conductor as it is being connected often torsionally stress the metallic strands sought to be connected, resulting in a less than optimum physical and electrical connection. A need therefore persists for connectors which can make a secure electrical connection to a multistranded insulated electrical conductor while minimizing twisting motions.

### SUMMARY OF THE INVENTION

According to one aspect of the invention, an electrical connector is provided which includes a body with a bore having an axis, and a cap through which a multistranded electrical conductor is threaded. The bore has, near its bottom, an inwardly sloping surface. The cap terminates at its inner end with a plurality of gores which, when they cam against the inwardly sloping surface, will collapse axially inwardly and will grasp the external surface of the conductor impaled on a center pin in the bore. The cap remains thus because a ridge formed on an external surface thereof has registered with a groove formed in the connector body bore, creating a high degree of strain relief and ensuring a good physical and electrical connection.

The present invention has application to connectors which connect to single insulated conductors as well as multiple insulated conductors. Multiple bores in a connector body can be arranged in parallel to each other, each bore receiving a respective insulated conductor for connection. The connector body can have all of the bores on one side of its body, or alternatively can have one or more conductor-receiving bores on opposed sides of its body. In many multiple-conductor embodiments, individual caps are provided for respective conductors and these are received into respective bores. In other multiple-conductor embodiments, at least one multiple-conductor cap is provided which has a plurality of cavities therethrough, each of which accepts a respective conductor. The multiple-conductor cap can have parallel shafts surrounding and defining respective ones of the cavities, and these shafts are received in respective bores in the connector body. A sealing elastomeric o-ring can be provided to seal each shaft to the connector body, or alternatively one o-ring can be provided which surrounds all of the cap shafts and seals between an enlargement of the multiple conductor cap and a face of the connector body.

The multiple bores can each have more than two grooves, and the caps which fit into them can have more than two ridges. Axial profiles of the surfaces making up these grooves and ridges can be straight or other than straight, such as convexly curved or concavely curved, as long as the grooves and ridges are made up of surface pairs in which the area of one such surface in the pairs is substantially greater than the area of the other member of the surface pair. An array of multiple bores in a connector body does not have to be two-dimensional but can instead be three-dimensional.

The grooves and ridges can be reversed, such that the ridges project from a generally cylindrical surface of a connector body and the grooves are formed in a sidewall of a cap cavity. In such an embodiment, the body can have one or more such ridges and the cap should have two or more grooves which fit to them. This reversed embodiment has particular application in connecting to insulated coaxial conductors, in which the connector body further has a plurality of elongate piercing fingers designed to pierce through the external layer of insulation into a conductive sheath of the coaxial conductor. In one coax embodiment, the connector body has a central bore for receiving a stripped central conductor of the coaxial conductor. In another coax embodiment, the connector body has, axially outwardly extending from a face thereof, a hollow prong adapted to pierce the insulation surrounding the central conductor and to electrically connect to that central conductor. A sloping surface inside of the cap cavity cams the fingers into engagement with the conductor one the cap is compressed onto the body.

In one embodiment, a connector for a coaxial conductor further has an elastomeric gasket adapted to closely fit to the external insulation of the coaxial conductor. When the cap is compressed to be snap-fit to the second, axially inward ridge on the connector body, the gasket is compressed between the shoulders of the piercing fingers and an axially outward end wall of the cap, sealing the cap to the external surface of the conductor.

### BRIEF DESCRIPTION OF THE DRAWINGS

Further aspects of the invention and their advantages can be discerned in the following detailed description, in which like characters denote like parts and in which:

FIGS. 1A-1D are isometric, top, front and axial sectional views of a cap or plug according to a first embodiment of the invention;

FIGS. 2A-2D are isometric, side, front and axial sectional views of a connector body for use with the cap shown in FIGS. 1A-1D;

FIGS. 2E and 2F are axial sectional views of the cap and connector introduced in FIGS. 1A-2D, showing two successive stages in the connection of a multistranded conductor;

FIG. 3A is an axial sectional view of a connector body and cap according to a second embodiment of the invention, shown together with a multistranded insulated conductor, a terminal portion of which has had the insulation stripped away;

FIGS. 3B and 3C are axial sectional views of the connector body, cap and conductor shown in FIG. 3A, showing successive stages in making a connection to the conductor;

FIGS. 4A and 4B are isometric views of a connector body and cap, respectively, according to a third embodiment of the invention;

FIG. 5 is an axial sectional view of a connector body and cap according to a fourth embodiment of the invention with curved beveled surfaces, showing a first stage of assembly;

FIG. 6 is an axial sectional view of a connector body and cap according to a fifth embodiment of the invention with curved beveled surfaces, showing a second stage of assembly;

FIG. 7A is an exploded axial sectional view of a connector body and cap according to a sixth embodiment of the invention adapted to terminate a stripped coaxial cable;

FIG. 7B is a detail of the piercing fingers of the connector seen in FIG. 7A and taken substantially along line 7B-7B of FIG. 7A;

FIG. 8A is an exploded axial sectional view of a connector body and cap according to a seventh embodiment of the invention adapted to terminate an unstripped coaxial cable;

FIG. 8B is a detail of the piercing fingers of the connector seen in FIG. 8A and taken substantially along line 8B-8B of FIG. 8A;

FIGS. 9A and 9B are axial sectional views of a coaxial connector body and cap, respectively showing first and second stages in terminating a coaxial cable;

FIG. 10A is an actual sectional view of an eighth embodiment of the invention showing a first stage of assembly;

FIG. 10B is a side view of a connector body of the embodiment shown in FIG. 10A;

FIG. 10C is a side view of the connector body and cap shown in FIG. 10A, showing a final state of assembly of the connector and cap to a nonstripped insulated conductor;

FIGS. 11A and 11B illustrated initial and final assembly stages of an in-line connector embodiment otherwise similar to the embodiment shown in FIGS. 10A-10C;

FIGS. 12A and 12B show initial and final assembly stages of a multiple-conductor embodiment adapted from the embodiment shown in FIGS. 10A-10C, with a unitary connector body and separate caps;

FIGS. 13A and 13B show initial and final assembly stages of a multiple-conductor embodiment in which both the connector body and cap are unitary;

FIGS. 14A-14C are axial sectional views of a family of caps according to a further embodiment of the invention, in which a cap is selected according to the diameter of the insulated conductor to which connection is to be made;

FIG. 14D is a side elevational view of one of the caps shown in FIGS. 14A-C;

FIG. 15 is an axial section view of a female connector body designed for use with the caps of FIGS. 14A-14C;

FIGS. 16A and 16B are axial sectional illustrations of initial and final assembly changes of the connector and caps shown in FIGS. 14A-C and 15;

FIG. 17A illustrates a first stage of assembly of a further embodiment employing a collar, cap and female connector body to make a connection to an unstripped insulated conductor;

FIGS. 17B-C respectively are end and side views of a collar for use in the embodiment shown in FIG. 17A;

FIG. 17D is a side elevational view of a cap for use in the embodiment shown in FIG. 17A;

FIG. 18 is an axial sectional view of a final assembly stage of the embodiment shown in FIG. 17A;

FIGS. 19A and 19B show initial and final assembly stages of an in-line connector adapted from the embodiment shown in FIGS. 17A and 18;

FIGS. 20A and 20B show initial and final assembly stages of a further embodiment of the invention; and

FIGS. 21A and 21B show initial and final assembly stages of an in-line connector embodiment developed from the embodiment shown in FIGS. 20A and 20B.

### DETAILED DESCRIPTION

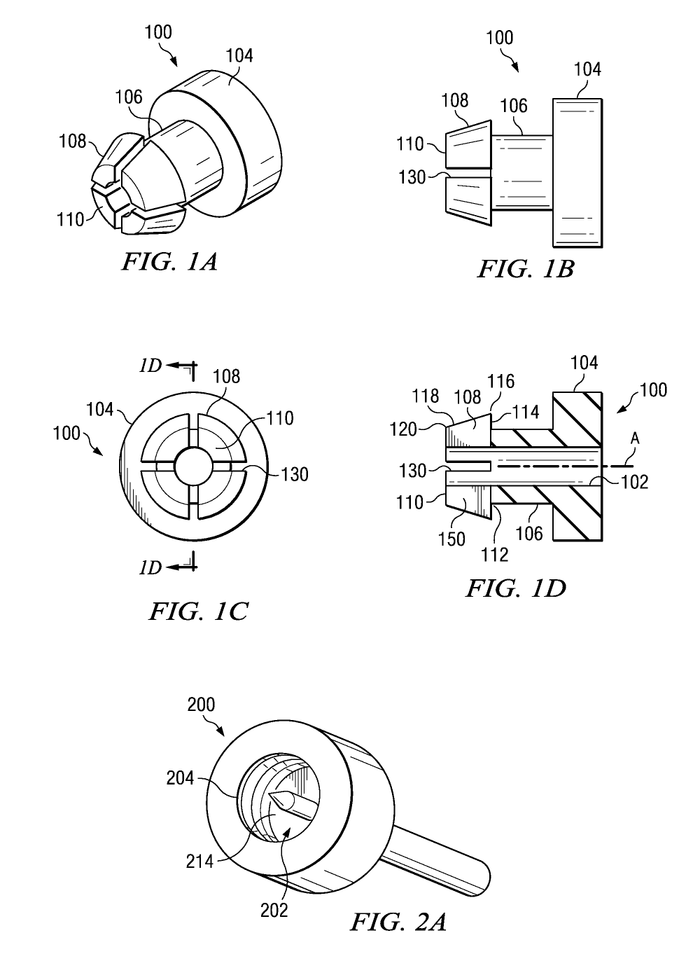

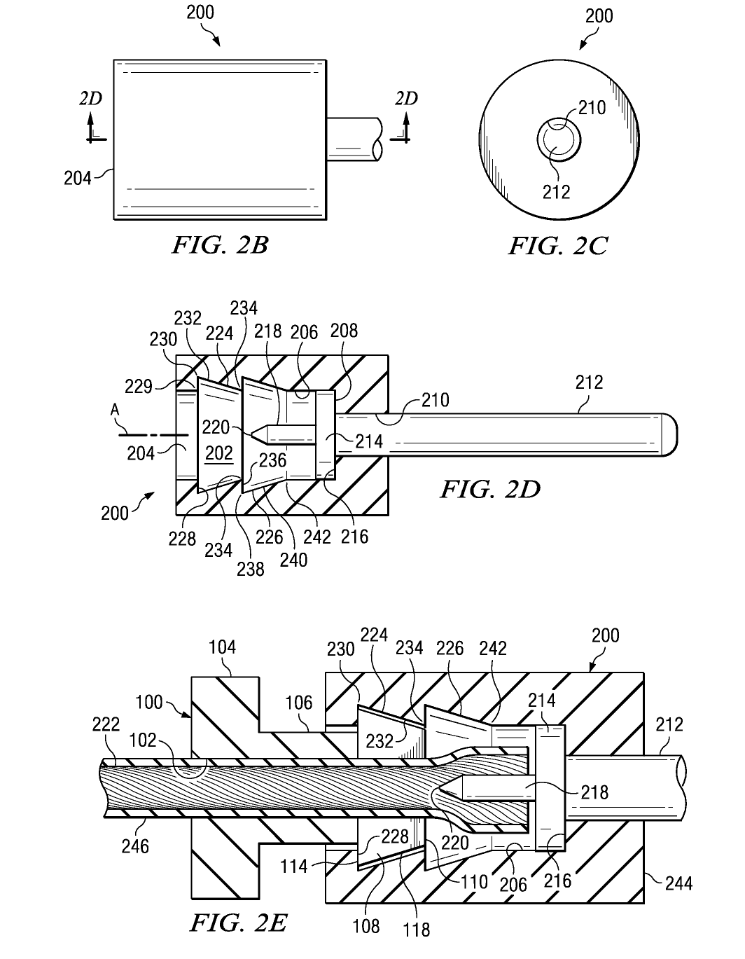

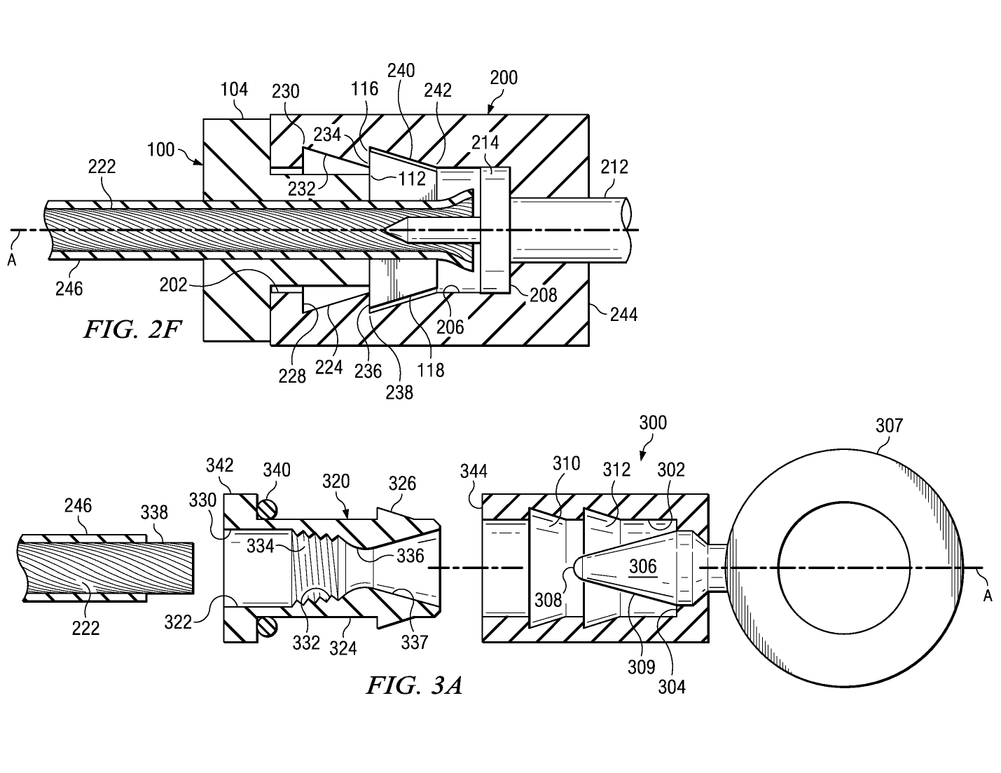

Referring first to FIGS. 1A-1D and 2A-2D, in a first embodiment of the invention, a connector body 200 has a generally cylindrical external shape. Throughout these illustrated embodiments, it should be understood that the body 200 and its analogs can be plastic, metal, or any other suitable material; body 200 does not have to be conductive. The body 200 has a bore 202 with an open end 204 and a generally cylindrical interior sidewall 206 which terminates in a bottom 208. The body 200 and the bore 202 are conveniently formed around an axis A. The body 200 preferably should be formed of a material that is somewhat elastic, so that it will stretch slightly and snap back during stages of insertion of the cap and conductor into the bore 202, as will be later described. But the body 200 should not be so elastic that the connection will easily fail because of the cap being pulled back out of the connector body.

The bottom 208 of the bore 202 has a central hole 210 through which is inserted a conductive element 212, in the illustrated case a pin connector. The conductive element 212 alternatively could be a spade connector, a battery terminal or any other shape adapted for connection to further electrical apparatus. In the illustrated embodiment, the conductive element 212 has a flange or base 214 which tightly fits to the sidewall 206 and is adapted to rest on the bottom 208 of the bore. In an alternative embodiment the conductive element 212 could have one or more radial processes meant to be in-molded into the back wall 216 of the body 200, as will be shown in other embodiments herein. The conductive element 212 has an upstanding and coaxial pin or prong 218 which extends from the bottom 208 axially outwardly toward the bore open end 204. The pin 218 preferably is beveled or pointed at its free end 220 so as to be adapted to impale the conductive strands of a multistranded insulated conductor 222, seen in FIGS. 2E and 2F. In this embodiment, the diameter of pin 218 is relatively small and, after its beveled or sharpened point 220, stays substantially constant until it joins with base or flange 214.

While bore 202 is generally cylindrical (or alternatively prismatic), it is not completely so. Importantly, the bore 202 has at least one, and in this embodiment two, grooves 224 and 226. The groove 224 is axially spaced away from the bore opening 204 and, at its greatest extent, has an inner diameter perpendicular to the axis A which is greater than the inner diameter across the opening 204. In the illustrated embodiment, the groove 224 is formed by a step or shoulder 228, at which the groove 224 begins to depart from the general coaxial and cylindrical surface 206 of the bore 202. The step or shoulder 228 extends from a point 229 radially outwardly by a predetermined distance to a radially outward end 230 thereof. Starting at point or end 230, a beveled surface 232 proceeds axially inwardly and radially inwardly for a predetermined distance until it terminates at point or end 234. In the illustrated embodiment, the shoulder 228 and the beveled surface 232 are surfaces of rotation around axis A. A diameter taken across the axis at point 234 is significantly less than the diameter taken at point 230. In this embodiment, the groove 224 is formed by a flat surface 228 and a frustoconical surface 232. The groove 224, which as will be explained acts as a detent or positioner for a cap, can take a form different from that shown; for example it can instead be formed by one or more convex or concave curved surfaces. Preferably, and regardless of the axial profile of the surfaces 228 and 232, axially inward surface 232 should have an area which is substantially greater than an area of axially outward surface 228.

In the illustrated embodiment, the first groove 224 is accompanied by a second groove 226 that is spaced down the bore 202 from groove 224, thus defining distinct axial positions in the bore 202. In this embodiment, the surfaces forming groove 226 are immediately adjacent those forming groove 224, although it could be otherwise. A step or shoulder 236 begins at point 234 and proceeds radially outwardly by a predetermined distance until point 238, at which it ends and a beveled surface 240 begins. The beveled surface 240 proceeds axially inwardly (that is, toward bottom 208) and radially inwardly (toward axis A) until point or end 242. At point 242, in the illustrated embodiment the generally cylindrical surface 206 resumes and continues to the bottom 208. A diameter taken across the axis at point 238 is greater than a diameter taken across the axis at point 242. Like groove 224, groove 226 in the illustrated embodiment is formed by two surfaces of rotation around axis A, a flat surface 236 disposed in a plane orthogonal to the axis, and a frustoconical surface 240 adjoining surface 236. But groove 226 could be formed by other surfaces.

Like groove 224, groove 226 acts as a detent or positioning means for the connector cap and other surfaces (such as curved ones) could instead be provided for this purpose. To ensure that pull-out is more difficult than completing the connection to begin with, the area of surface 240 should be preselected to be much greater than that of surface 236. Further, while in this illustrated embodiment grooves 224 and 226 are shown to be continuous or endless, and circumferentially extend around the entirety of the connector bore sidewall 206, grooves 224 and 226 could instead be discontinuous or even be made up of disconnected portions, and still be able to perform their cap-detenting or positioning function. In a similar fashion, the ridge on cap 100 (described below) could be chosen to be discontinuous rather than circumferentially endless.

The cap 100 for this embodiment is illustrated in FIGS. 1A-1D. The cap 100 has a bore or through-hole 102 adapted to receive the multistranded conductor 222 (seen in FIGS. 2E and 2F). In this illustrated embodiment, most of the surfaces of cap 100 are formed as surfaces of rotation around the axis A. An outer axial end 104 of the illustrated embodiment is enlarged, such that its outer diameter across the axis is greater than the inner diameter across connector body bore entrance 204 (see, e.g., FIG. 2D). The cap 100 has a central portion 106 of cylindrical shape whose external diameter is less than that of outer axial end 104, and which is also less than the respective inner diameters taken at points 229 and 234 inside bore 202 of connector body 200. The cap 100 further has an enlargement or ridge 108 formed somewhere on its external surface, in this illustrated embodiment adjacent its axial inner end 110. Ridge 108 has an outer diameter at its greatest extent which is greater than the inner diameter of the bore entrance 204.

In this embodiment, the ridge 108 is formed by two surfaces of rotation which are roughly complementary to the surfaces forming grooves 224 and 226. Starting at point 112 on the generally cylindrical middle section 106, a flat, annular surface 114 projects radially and orthogonally outwardly to a point 116. Point 116 marks the end of a frustoconical surface 118, which extends axially inwardly (that is, toward the bottom 208 of bore 202 when the cap 100 is being used) and radially inwardly to a point 120, which in this embodiment the same radial distance away from the axis A as is surface 106. In the illustrated embodiment point 120 happens to be a portion of inner axial end 110 of cap 100, but the ridge-creating surfaces 114, 118 can be positioned anywhere on the exterior surface of cap 100 (with commensurate adjustments of the positions of grooves 224, 226).

The angle of bevel of frustoconical surface 118 does not have to be the same as the angles of connector body frustoconical surfaces 232, 240, and in one commercial embodiment they in fact are different. The first frustoconical surface 232 can be selected to somewhat loosely receive the cap surface 118. On the other hand, the second connector body frustoconical surface 240 can be selected to induce a camming effect on the surface 118; as will be later described herein, the surface 240 can be relatively steep so as to force the leaves of a split surface 118 radially inwardly to grip the conductor insulation. While the illustrated axial profiles of ridge-creating surfaces 114, 118 are straight, they can be chosen to be otherwise, such as convexly or concavely curved. Surface pairs 114, 118 should be chosen such that the area of surface 118 greatly exceeds that of surface 114.

The cap 100 can be formed of plastic, metal or any other suitable material. It preferably is somewhat elastic, that is, it will deform and return to its initial shape after the deforming force is removed. This elasticity permits the cap to “snap” to either of the grooves 224, 226 after being forced beyond body bore sidewall constrictions in front of them. Conveniently, both cap 100 and connector body 200 can be injection-molded using a thermoplastic or thermosetting polymer.

In this embodiment, the cap 100 has at least one, and more preferably a plurality (such as four) slits or openings 130 which extend from the inner axial end 110 of cap 100 axially outwardly for a predetermined distance. In the illustrated embodiment, the slits 130 are each arranged to lie in planes including axis A, but they don't need to be; preferably, they should extend at least roughly longitudinally. In the illustrated embodiment, the slits 130 extend for the same distance as, and are limited to, the frustoconical surface 118, but conceptually the positioning of slits 130 and of ridge 108 are entirely independent of each other, as they do separate jobs. The function of ridge 108 is to index the cap 100 to one of the connector body grooves 224, 226; the function of the slits 130 is to permit the portion of cap 100 adjacent inner axial end 110 to compress inwardly. In the illustrated embodiment the slits 130 are rectangular in shape but they could also be triangular or take another shape whereby more material is removed the farther one proceeds inwardly on the axis A.

FIGS. 2E and 2F illustrate the operation of the slit-cap embodiment of the invention introduced by FIGS. 1A-1D and 2A-2D. Prior to the time shown in FIG. 2E, a multistranded insulated conductor 222 is inserted through the bore of cap 100 and is impaled on prong 218. The outside jacket 246 of the insulated conductor 222 may be marked at measured intervals which would allow the user to know when the conductor has been inserted by a correct length, instead of assuming that the conductor has been pushed in far enough because it feels bottomed out. The markings preferably would occur in pairs: a first mark would show where the end of the conductor should be cut, and a second mark, at a predetermined distance away from the first, would show the amount of conductor to be inserted into the connector. In one embodiment, the cap-connector combination 100, 200 is provided to the end user as a single unit, and in this instance the conductor 222 is inserted through the cap bore 102 while the cap 100 is in the position shown, in which the cap ridge 108 is detented to the first groove 224 in the connector body 200. In another embodiment, the conductor 222 is inserted into the bore 202 prior to the insertion of cap 100 into same.

The cap 100 is then advanced inwardly along axis A from groove 224 to groove 226. The ridge 108 will seat into or snap into place inside groove 226 and will thus indicate to the user that the cap 100 has been pushed down the bore 202 far enough. Forcing the cap 100 further into bore 202 from first groove 224 could, in some embodiments, be done manually; in other embodiments and particularly where a permanent connection is wanted that will exhibit a large amount of strain relief, a plier (not shown), preferably one with a stop to prevent over compression, may be used to compress ends 104, 244 toward each other until ridge 108 of the cap 100 is seated in the groove 226 of the bore 202.

As this is being done, the frustoconical surface 118 is forced radially inwardly, such that that portion of the internal cap sidewall between the slits 130 will grip the insulation 246 of the conductor 222. The frustoconical surface 118 is cammed inwardly by being forced against frustoconical surface 240 of the second groove 226. The resultant gripping by cap 100 of the conductor 222 aids in strengthening the physical connection. In another embodiment (not shown), a further beveled surface inside the body bore 202 may coact with the slit end 110 of cap 100, while ridge 108 may be placed at a more axially outward position on the exterior surface of cap 100. The position of detenting of indexing grooves 224, 226 would also be more axially outward and frustoconical surface 240 would have a detenting function, but would no longer have a cap end-compressing or camming function.

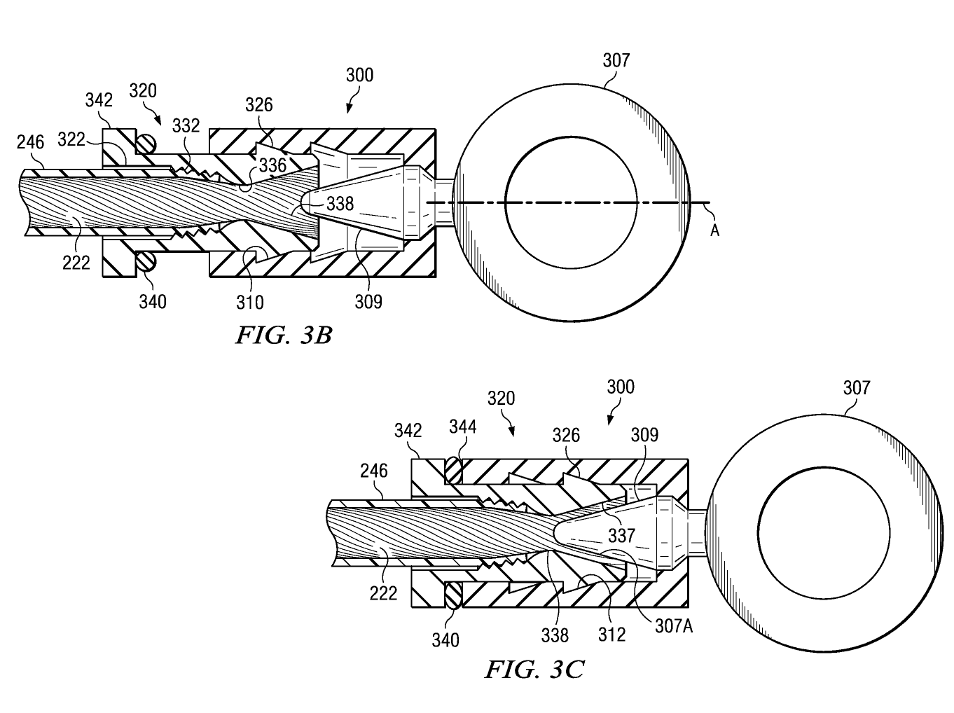

FIGS. 3A-3C illustrate a further embodiment of the invention. In this embodiment, a connector body 300 has a generally cylindrical bore 302 with a bottom 304. A prong 306 of a conductive element 307 extends axially outwardly into the bore 302 from the bottom 304, and in this embodiment has a convexly curved surface 308 at a free end 309 thereof. While the bore 302 is generally cylindrical, it is also provided with at least one, and more preferably two, grooves 310, 312, formed at two different axial distances from the bottom 304 and the prong 306. The grooves 310, 312 are each formed by a juxtaposition of orthogonally upstanding annular surfaces and radially and axially inwardly sloping surfaces, as more fully described previously for the first illustrated embodiment.

A cap 320 has an inner bore 322 and a generally cylindrical outer surface 324 which, however, includes a radially outwardly extending circumferential ridge 326. The ridge 326 is formed in such a way that it may register with either of the body bore grooves 310, 312, and is built of surfaces complementary to the surfaces making up those grooves. While the ridge and groove structures 310, 312, 326 are shown as constructed of annular and frustoconical surfaces, they can be selected otherwise, and for example can be constructed of surfaces which are concavely or convexly curved in axial profile. The leading surface of ridge 326 should be chosen to have an area which is much greater than the trailing surface thereof, and the reverse should hold true for the surfaces making up each of the grooves. When designing the connector, the positions of grooves and ridge 310, 312, 326 can be correspondingly displaced up and down the axis A as is convenient, since those positions are chosen independently of the conductor-connecting structures radially interior to them.

The cap bore 322 has an axially outwardly disposed end 330 with an interior diameter sized to receive a multistranded conductor 222 with its insulation 246 intact. But as one proceeds axially inwardly, the diameter of bore 322 begins to constrict. Also at this point, threads 332 appear, and are provided to threadably and sealingly engage with the conductor insulation 246. In the illustrated embodiment, the threads are placed on a linearly constricting or beveled throat 334 that provides gradually increasing resistance as the insulation 246 is threaded onto it. The frustoconical disposition of the threads 332 also permits some variation in conductor outer diameter, as any within a predetermined range will be able to be sealingly connected using this embodiment. Instead of threads 332, a plurality of nonhelical, coaxial sealing rings (not shown) could be provided, and these could have a “shark tooth” profile to permit the easy insertion of insulation 246 beyond them, but make the extraction thereof in an axially outward direction more difficult.

Axially inwardly from the threads 332 is a constriction 336, which only permits the stripped conductor strands 338 to pass through it. The exterior surface of insulation 246 may be marked so that an optimal terminal portion thereof is stripped, and/or a tool may be provided for this purpose, or the conductor 222 may be provided with one end pre-stripped together with connector components 300, 320 in kit form. After constriction 336, at some point (in this illustrated embodiment, immediately) the bore will flare out again in a circumferential beveled surface 337 that corresponds in mirror image to the surface 309 of conductive element 307. The cap 320 also has a sealing o-ring 340 which is disposed axially inwardly of a cap enlargement 342 that forms cap 320's axial outer end. The o-ring 340 will sealingly engage with an axially outer end 344 of the connector body 300.

The operation of this embodiment is illustrated in FIGS. 3B and 3C. In FIG. 3B, a multistranded insulated conductor 222 has had its insulation 246 stripped from a predetermined terminal portion (which may be marked in advance for stripping), leaving bare conductive strands 338. The cap 320 may be provided to the end user preassembled to the body 300, as shown, with the cap detented to the first ridge 310. After stripping the conductor 222 is threaded into cap bore 322, wherein the insulation 246 is threaded onto cap threads 332. This may be accomplished by rotating the cap 320 relative to the conductor 222. Where a series of coaxial sealing rings are used instead, the conductor 222 may simply be inserted without twisting into cap bore 322 as far as it can go. When fully engaged, the stripped portion of the conductive strands 338 will extend through the throat or constriction 336.

Once the threads 332 have fully engaged the insulation 246, the cap 320 and conductor 222 are advanced together until the cap ridge 326 snaps into or seats in second groove 312 (FIG. 3C). This compression may be accomplished manually in some embodiments and may require a tool in others. In this position the conductive strands 338 are clamped between the convex beveled surface 307A of conductive element 307 and the concave beveled surface 337 of cap 320. This makes a secure physical and electrical connection to the conductor 222. Also in this position, the o-ring 340 will be compressed between the enlarged cap portion 342 and an axial outward end surface 344 of the connector body 300.

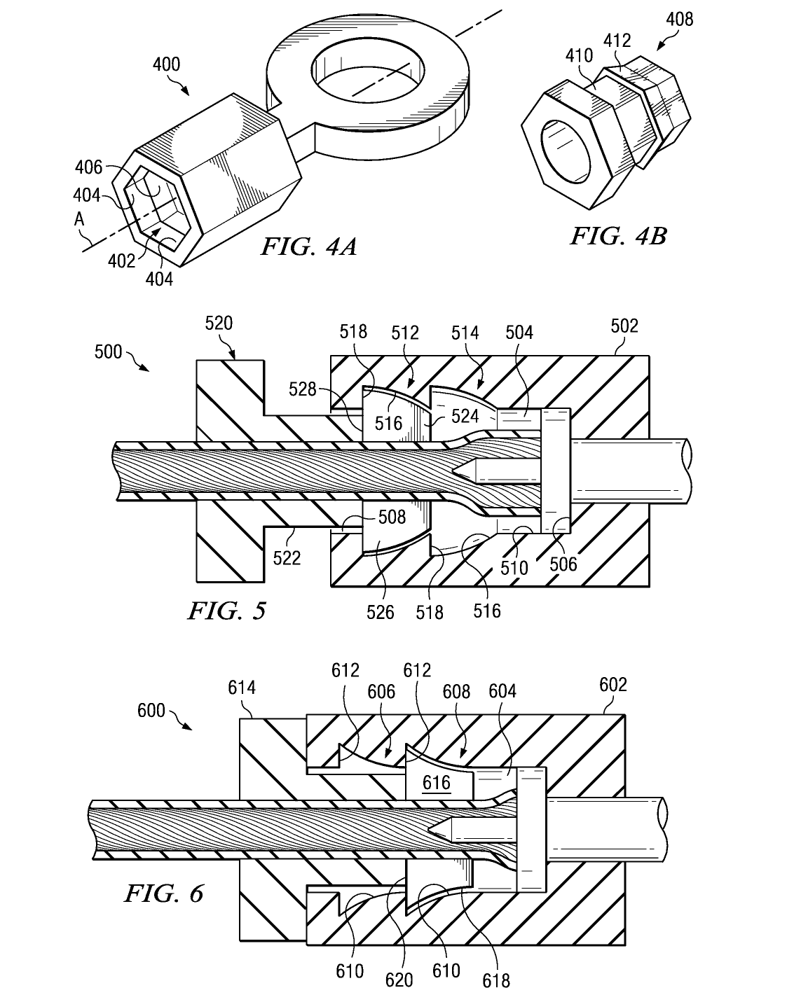

FIGS. 4A and 4B illustrate a further variation of the invention, in which a connector body 400 has a generally prismatic, rather than a generally cylindrical, bore 402. The bore or cavity 402 is shown with six sides 404 but prisms of other shapes can instead be provided, or indeed any other noncircular cross sectional shape that stays relatively constant as one proceeds down the axis A of the bore 402. Each or at least some of the sides 404 will be provided with at least one, and preferably two, grooves 406, which can have a frusto-pyramidal shape and each be formed of two planar surfaces. A cap 408 will have a generally prismatic external surface 410 which is adapted for insertion into the connector cavity 402. A preferably circumferential ridge 412, which is preferably but not mandatorily made up of another set of frustopyramidal surfaces, is adapted to register or snap into a selected one of the grooves 406. Ridge 412 and grooves 406 can be alternatively be made up of surfaces which are convexly, concavely or otherwise curved in axial profile, but in any event, a leading surface making up ridge 412 should have a surface area which is substantially greater than a trailing surface thereof, and the reverse should hold true for each of the grooves 406.

This embodiment is possible because the cap 408 fastens the conductor (not shown) in place with a straight axial movement rather than a twisting movement. Indeed, a noncylindrical embodiment such as that shown in FIGS. 4A and 4B may be preferred in those instances where torsional damage to the conductor is sought to be prevented, because the end user will be forced to insert the cap 408 into the bore 402 in an axially straight motion, and the noncircularity of the cap and the bore effectively prevent one from being twisted with respect to the other.

FIG. 5 shows a connector 500 according to an embodiment of the invention in which the surfaces of the cap ridge and cavity grooves are other than straight in axial profile or section. A connector body 502 has a bore or cavity 504 with a bottom 506 and an opening 508. The cavity 504 has a generally cylindrical sidewall 510 (which in other embodiments can have an axial cross section that is other than circular, such as oval or polygonal) with a first groove 512 proximate the cavity opening 508 and a second groove 514 displaced axially inwardly from the first groove 512. Each of the grooves 512, 514 is made up of a first, axially inward surface 516 and a second, axially outward surface 518 which joins to the first surface 516. The area of the axially inward surface 516 substantially exceeds that of the axially outward surface 518. It is preferred but not absolutely required that points on any axial section of the surfaces 516, 518 vary monotonically with respect to their radius from the connector axis. Many surfaces satisfy this general criterion; in the illustrated embodiment, the first beveled surface 516 is concavely curved when taken in axial section (as shown), while the second surface 518 is straight in axial section and is formed to conform to a plane which is orthogonal to the connector axis.

A cap 520 has a shaft 522 with a diameter which is slightly smaller than the diameter of the cavity 504, and which is similar in cross-sectional shape to the general cross-section of cavity 504. A ridge 524 is formed to extend radially outwardly from the general exterior surface of shaft 522. Here, ridge 524 is disposed on the front end of cap shaft 522 and has a leading surface 526 and a trailing surface 528. As for each of grooves 512 and 514, a surface area of the leading surface 526 should be much larger than a surface area of the trailing surface 528. The illustrated surface 526 is a beveled surface which is convexly curved, while surface 528 is formed to be planar and substantially orthogonal to the connector axis. Because the surface areas of surfaces 516, 526 greatly exceed the areas of respective adjoining surfaces 518 and 528, more force will be required to pull the cap 520 out of the connector body 502 than it will take to push the cap into either groove 512 or groove 514. This result will be obtained through a wide range of different shapes which surfaces 516, 518, 526 and 528 can take. One will obtain this result if the beveled surfaces 516, 526 are straight in cross section, as their analogs are in FIGS. 1-4B and 6A-21B, or take another shape as is shown here and in certain embodiments described below.

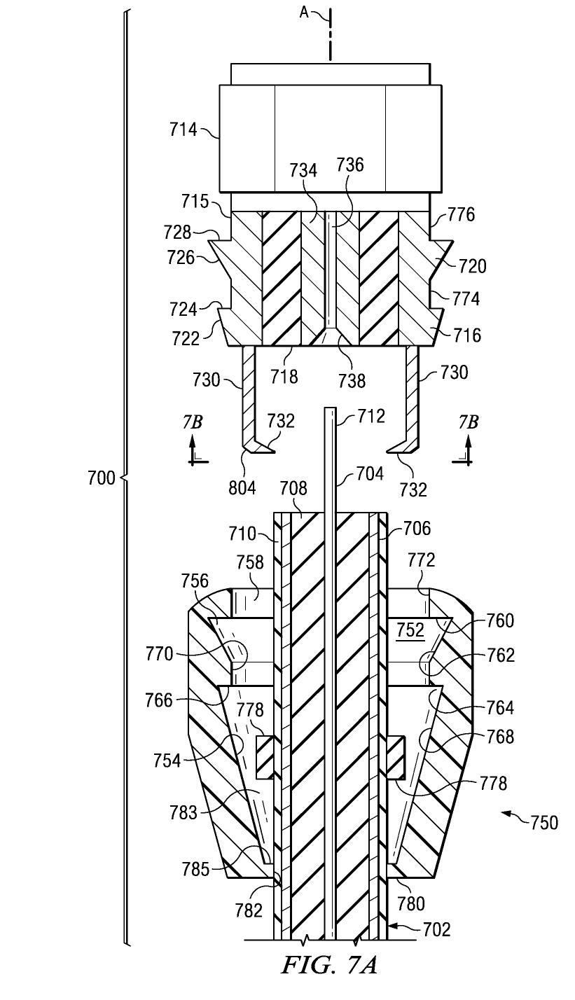

FIG. 6 illustrates an embodiment 600 which in general is similar to connector 500 shown in FIG. 5, but with a reversal in certain curved shapes. A connector body 602 has a bore or cavity 604 which has formed therein a first groove 606. The first groove 606 is disposed axially outwardly from a second groove 608. Each groove 606, 608 is formed by two adjoining surfaces: an axially inward first surface 610 which is convex in axial section, and a second, axially outward surface 612 which extends radially inwardly from an end of surface 610, which is straight in axial section, and which substantially conforms to a plane which is orthogonal to the connector axis. The surface pairs 610, 612 respectively making up grooves 606, 608 do not have to be identical and in one embodiment the areas of surfaces 610, 612 forming groove 606 can be intentionally larger than those of respective surfaces 610, 612 forming groove 608. Groove 608 can be intentionally chosen to be tighter than groove 606 to have a radially inwardly camming effect on a connector cap 614. The cap 614 has a ridge 616 which is formed by two surfaces which at least roughly mirror cavity surfaces 610, 612: a leading surface 618 which is concavely curved in axial section or profile, and a trailing surface 620 which extends from an end of the leading surface, which is straight in axial section or profile, and which substantially conforms to a plane which is substantially orthogonal to an axis of the connector 600. As in the other embodiments shown herein, the surface area of the axially inward surfaces 610, 618 substantially exceeds those of the axially outward surfaces 612, 620, and this in turn means that it will be harder to pull cap 614 out of either groove 606, 608 than it will to push cap 614 into groove 606, 608.

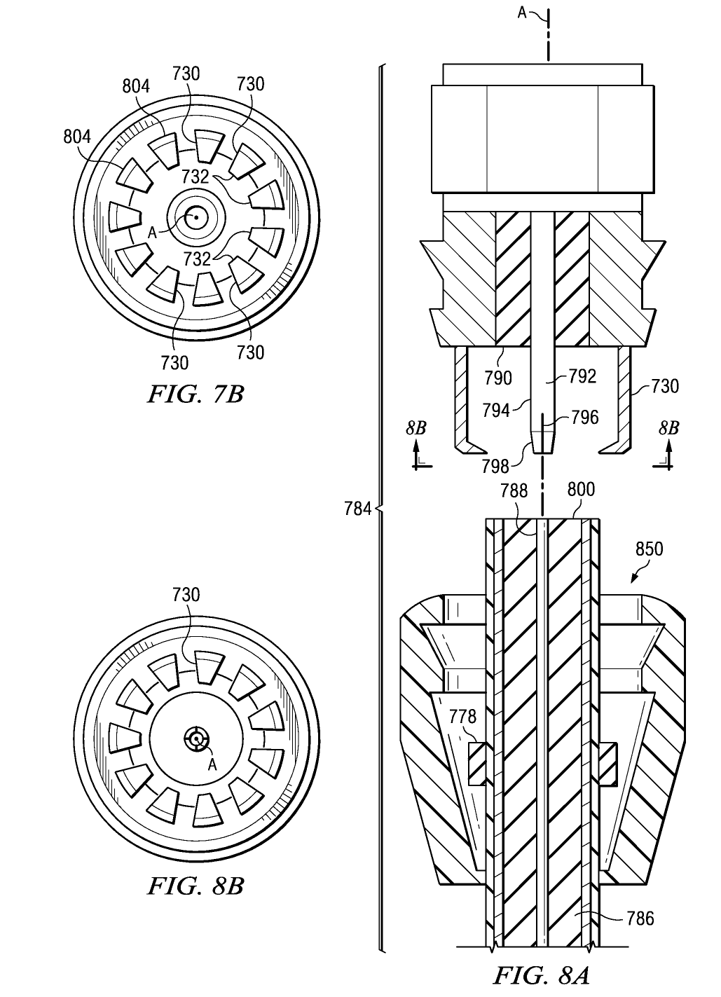

FIG. 7A is an exploded view of a connector 700 suitable for terminating a coaxial cable 702. The coaxial cable 702 has a solid center conductor 704 and a conductive sheath 706, both of which require connection to further electronic components. Sheath 706 and central conductor 704 are separated by coaxial insulation 708 and the entirety of cable 702 is protected by a layer of external insulation 710. This embodiment is provided for coaxial conductor ends from which insulation 710, sheath 706 and insulation 708 have been stripped, leaving a bare length 712 of the central conductor 704.

A coaxial cable connector body 714 has a generally cylindrical exterior surface 715 (as “cylindrical” is understood in its broad mathematical definition, meaning having a substantially uniform cross section throughout its axial length; e.g. body 714 could be polygonal, oval or otherwise noncircular in axial cross-section) that is formed in whole or in part of a conductive material. In the illustrated embodiment, the body 714 has a first ridge 716 proximate a front face 718 of the body. The ridge 716 is formed to be at an angle to the axis A and is preferably orthogonal thereto. Spaced from this first ridge 716 to be more remote from the front face 718 is a second ridge 720. Second ridge 720 is formed at an angle to the axis and preferably is orthogonal thereto. Both the first and second ridges are preferred to be circumferential relative to the axis A of the connector 700, but they could be discontinuous. A radius of ridge 716 at its largest point is greater than a radius of the generally cylindrical surface 715 of the body 714. Preferably the greatest radius of ridge 720 is greater than the greatest radius of ridge 716.

The ridge 716 is formed by a leading surface 722 which extends axially rearwardly and radially outwardly from the general cylindrical surface 715, and a trailing surface 724 joined to an outer end of the leading surface 722 and extending radially inwardly back to the general exterior surface 715. The leading surface 722 and the trailing surface can each take various shapes (e.g., they can be straight, convexly curved or concavely curved), but the leading surface 722 should always have an area which is substantially greater than the area of trailing surface 724. Surface pairs 722, 724 which satisfy this criterion will exhibit more resistance to cap/conductor pullout than they will to cap/conductor assembly to the body 714. In the illustrated embodiment, surface 722 begins at front connector body face 718 and is frustoconical; in other embodiments surface pairs 722, 724 could be displaced rearwardly on the general exterior surface 715. The trailing surface 724 in the illustrated embodiment is annular and conforms to a plane which is orthogonal to axis A.

In the illustrated embodiment the second ridge 720 is likewise formed by a leading surface 726 and trailing surface 728. The leading surface starts at the radius of the general exterior surface 715 and proceeds radially outwardly and axially rearwardly until its junction with trailing surface 728, at which point its radius from axis A is greater than the radius of the generally exterior surface 715. Trailing surface 728 extends radially inwardly until it meets the general outer surface 715 of the connector body 714. In the illustrated embodiment, surface 726 is frustoconical and surface 728 is annular and orthogonal to axis A, but they could be chosen to be otherwise. For example, surfaces 726 and/or 728 could be convexly or concavely curved. But the area of leading surface 726 should always be greater than that of trailing surface 728.

Conductively connected to the connector body 714 are a plurality of conductive piercing fingers 730, two of which are shown in FIG. 7A. FIG. 7B is an end-on view of fingers 730, illustrating their axially circumferential distribution. Each finger 730 has a shoulder 804 from which extends in a radially inward direction a point or edge 732 that is long enough and sharp enough to pierce through the insulation 710 and contact conductive sheath 706. Points or edges 732 should not be so long that they would penetrate to central conductor 712. In an initial, uncompressed position, the fingers 730 do not engage the external insulation 710 of coaxial conductor 702 but permit the insertion of coaxial conductor 702 to the face 718 of the body 714.

In this embodiment, the connector body 714 has a conductive central portion 734 with a bore 736. Bore 736 may be beveled at its entrance 738 so that stripped central conductor 712 may be more easily inserted into bore 736.

The other major component of coax connector 700 is a cap indicated generally at 750 which has an axial cavity 752 through which the coax conductor 702 is threaded. The cap 750 may be formed of either conductive or insulative material. An internal sidewall 754 of the cap 750 has a first groove 756 formed to be near an axially inward opening 758 of the cap 750. The groove 756 is formed at an angle to axis A (preferably at right angles to it) and has a radius at its deepest point from axis A which is greater than the radius of an adjacent portion of the inner cavity sidewall 754. The first groove 756 is made up of a first, leading surface 760 and a second, trailing surface 762. The area of leading surface 760 should be chosen to be substantially less than that of the trailing surface 762. In the illustrated embodiment, the leading surface 760 is formed to be an annulus at right angles to axis A, and the trailing surface 762 is formed to be frustoconical. Surfaces 760, 762 may be chosen to be straight in axial cross section or profile (as shown) or could be convexly or concavely curved, or take other shapes.

The internal sidewall 754 has a further, second groove 764 which is formed to be axially outward (here, downward) from the first groove 756. The second groove 764 is also formed of a respective leading surface 766 and a trailing surface 768, where the area of the leading surface 766 is substantially less than that of the trailing surface 768. Groove 764 is formed at an angle to axis A (preferably at right angles to it) and has a radius at its deepest point from axis A which is greater than the radius of an adjacent portion of the inner cavity sidewall 754. The leading surface 766 is here chosen to be an annulus at right angles to axis A, while the trailing surface 768 is chosen to be frustoconical. As in other surface pairs discussed herein, surface pair 766, 768 can be chosen to be other than straight in axial profile, such as convexly or concavely curved.

In the illustrated embodiment, the grooves 756 and 764 are spaced apart by a surface 770 which is parallel to axis A. Surface 770 can be cylindrical or prismatic, for example. First groove 756 is spaced from opening 758 by a surface 772 which is parallel to axis A and whose length in an axial direction is about the same as the axial length of surface 770. These surfaces 770, 772 match up with an axially parallel exterior surface or land 774 on connector body 714, spacing apart ridges 716 and 720, and an axially parallel exterior surface or land 776 on connector body 714, axially forward (here, upward) of ridge 720.

The connector 700 also includes an “o-ring” or gasket 778 made out of an elastomer and which preferably has a rectangular (rather than circular) cross-section. The o-ring or gasket 778 is sized to closely fit on the exterior surface of the insulated conductor 702.

An outer axial end wall 780 of the cap 750 has an opening 782 which closely receives the conductor 702. A section 783 of the inner sidewall 754, here shown to be continuous with trailing surface 768, tapers from the groove 764 axially outwardly such that its radius gradually decreases. Preferably, at an outer axial end 785 of the surface 783, the radius of surface 783 is chosen to be smaller than an outer radius of the gasket 778.

FIGS. 8A-B show an alternative embodiment of a coaxial connector 784 according to the invention meant to connect to an insulated coaxial conductor 786 which has an unstripped central conductor 788. A connector body 790 of the connector 784 has a conductive coaxial tube or hollow prong 792 whose sidewall 794 may be slit with a slit 796, as shown. A sharpened end 798 of the prong 792 is adapted to penetrate the interconductor insulation 800 of the conductor 786, so as to surround and contact a length of the central conductor 788. Outside of the structure provided to connect to the center conductor 788, the cap 784 is identical to cap 700 illustrated in FIGS. 7A-B.

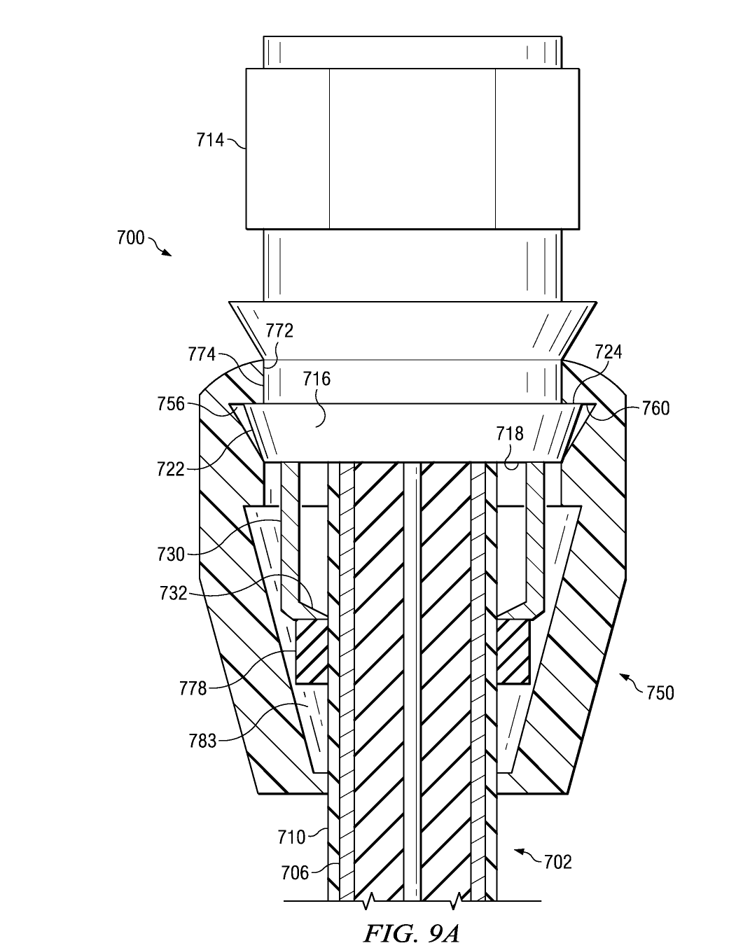

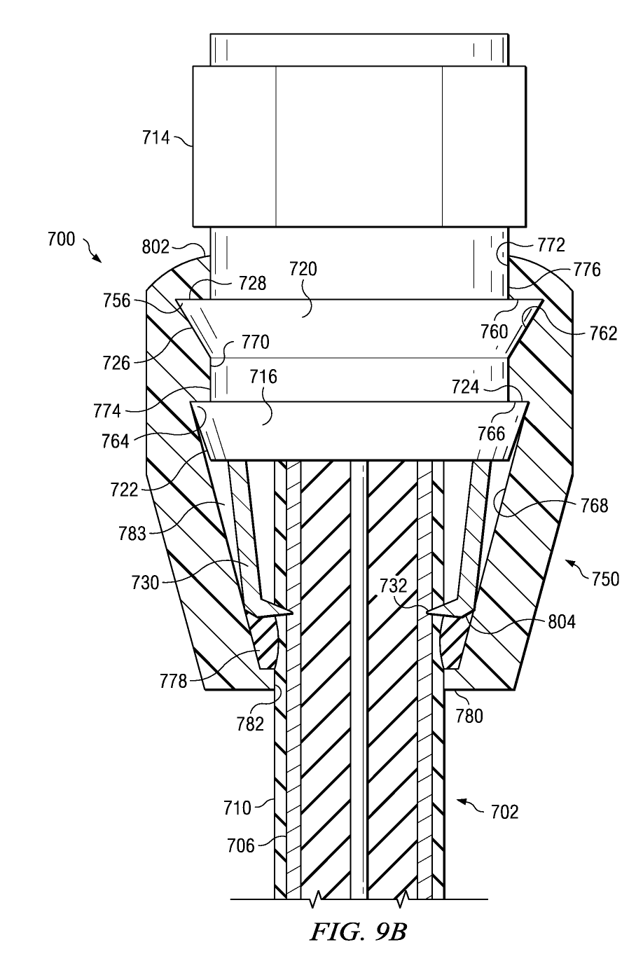

A first stage of termination of conductor 702 by connector 700 is shown in FIG. 9A. At this stage, the conductor 702 has been inserted until it abuts inner face 718. In the instance that a conductor 702 has been provided which has a stripped central conductor 712, the stripped portion is received within the interior of the connector body 714. In the instance that an unstripped coaxial conductor 786 is provided, the connector 784 of FIGS. 8A-8B is used, wherein the hollow prong 792 (not shown in this FIGURE) makes connection with the center conductor.

The beginning surface 772 of the cap 750 has been snapped over the first ridge 716, so that axially parallel surface 772 rests on connector body surface 774 and first groove 756 is in registry with the first ridge 716. The connector 700 may be provided to the user this way, in a preassembled condition. In this posture the prongs or fingers 730 have yet to pierce through the outer insulation 710 of the conductor 702.

FIG. 9B shows a second, final stage of connection. The cap 750 has been pushed or compressed, either manually or with the aid of a plier-like tool (not shown), axially inwardly (upward in this FIGURE) until the axial inner end 802 of the cap 750 has slid over surface 762 of the connector body 714 until end 802 “snaps” past right annular trailing surface 760 to rest on land or parallel surface 772. While this is happening, surface 774 of the cap 750 pushes up leading surface 722 and snaps over connector body trailing surface 724, to fit onto parallel surface 770 of the connector body 714. In this condition, and in the illustrated embodiment, two ridges 716, 720 mate with respective grooves 764, 756.

Also during this compression step, camming surface 783 of the cap 750 pushes tips 732 of piercing fingers 730 through the outer insulation 710 of conductor 702 and into the conductive sheath 706. Finally, the elastomeric “o” ring or gasket 778 is compressed between an axially inward wall of cap end 780 and an axially outer end or shoulder 804 of each finger 730, sealing the cap bore end 782 to the external surface of insulated conductor 710.

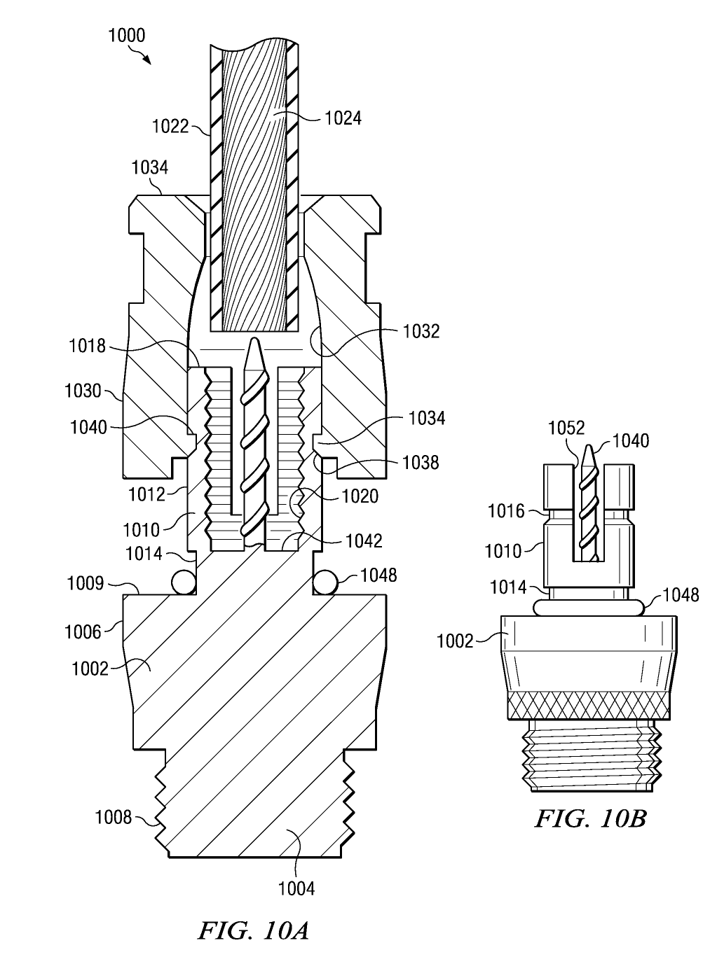

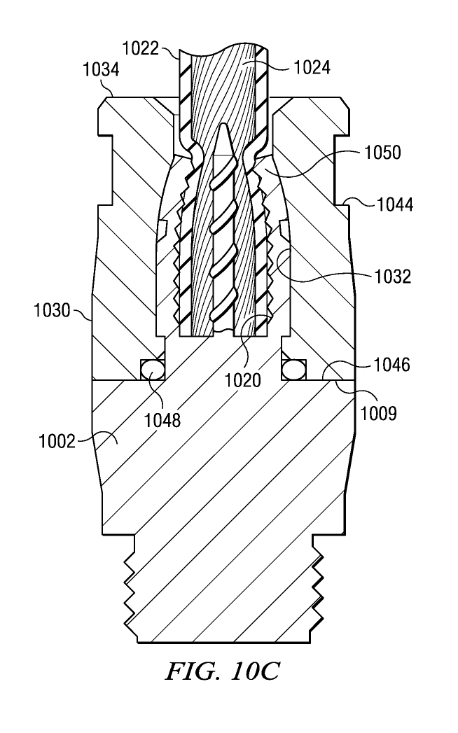

In the embodiment shown in FIGS. 10A-10C, a single-end connector indicated generally at 1000 has a preferably conductive female body 1002. The external radial surface of a rear end 1004 of the body 1002 can be screw-threaded to accept any of a plurality of different equipment connectors, such as a spade, a banana plug or a pin (not shown). An external surface 1006 forward of the screw threads 1008 can take any convenient shape, such as a hex shape or a shape which is knurled. The body 1002 has a substantial step or surface 1009 which, in the illustrated embodiment, is orthogonal to the longitudinal axis of the connector 1000.

At its forward axial end, the connector body 1002 has a substantially cylindrical tube 1010. An external surface 1012 of the tube 1010 is cylindrical in cross section (where “cylindrical” takes its broad mathematical definition). The tube 1010 has a pair of grooves: an axially inward groove 1014 which is close to or adjoins the step 1009, and an axially outward groove 1016 which is spaced a little way rearwardly from a front end 1018 of the tube 1010. The grooves 1014 and 1016 are spaced a considerable distance apart from each other on tube 1010, and define initial and final assembly positions of a cap which indexes to them, as will be described below.

An internal surface 1020 of the tube 1010 is roughened or threaded in order to grip the external insulation 1022 of an insulated conductor 1024 to be connected by connector 1000. An internal diameter of the tube 1010 is chosen to be at least a little larger than an external diameter of the conductor 1024.

A cap 1030 has an internal bore or cavity 1032 with a ridge or constriction 1034 at its inner axial end 1036. The ridge 1034 may have a leading beveled or sloped surface 1038 that has a surface area that is larger than a trailing surface 1040, which in the illustrated embodiment is annular and at right angles to the longitudinal axis A of the connector 1000. From ridge 1034, and proceeding forward along axis A, the surface of bore or cavity 1032 quickly increases in diameter until it is larger than an external diameter of the tube 1010. The surface of cavity 1032 then begins to decrease in diameter until is intentionally is less than the external diameter of tube 1010 by the time one reaches an outward axial end 1034 of the cap 1030.

In the operation of this embodiment, the connector 1000 may be provided to the user in the condition in which it is shown in FIG. 10A. The user then inserts a conductor 1024 through end 1034 of the cap 1030 and into tube 1010 of the female connector body 1002. In the illustrated embodiment the user twists the conductor onto a helically threaded center pin 1040 which is conductively joined to body 1002; in another embodiment the helically threaded center pin 1040 may be replaced with a nonthreaded center pin so as to permit an impalement of the conductor 1024 onto such a pin without twisting. In either event the conductor 1024 is advanced down within tube 1010 until a base 1042 of the tube 1010 is reached.

FIG. 10C shows a final stage of assembly. The cap 1030 has been pushed down axis A, either manually or with the aid of a tool which can fit onto land 1044 or end 1034, until a front end 1046 of the cap 1030 mates with surface 1009 of the body 1002. It is preferred that the surface 1046 of cap 1030 mate or be congruent with the surface 1009 of the connector body 1002. When this happens, the cap ridge 1034 will register with axially inward groove 1014, locking cap 1030 in place relative to body 1002. The cap ridge also preferably compresses an O ring 1048 disposed in groove 1014 to seal the cap 1030 to the body 1002.

As cap 1030 is slid home on body or base 1002, the surface of cavity 1032 will begin to compress the sidewall of tube 1010 inwardly until its internal surface 1020 begins to grip and compress the insulation 1022 of conductor 1024. This compression is maximized at cavity constriction 1050 near end 1034. The compression is made possible or enhanced by longitudinal slits 1052 (FIG. 10B) in tube 1010, which more easily permit the collapse of the sidewall of malleable tube 1010 onto the conductor 1024. The result is a firm connection between the conductor 1024 and the connector 1000.

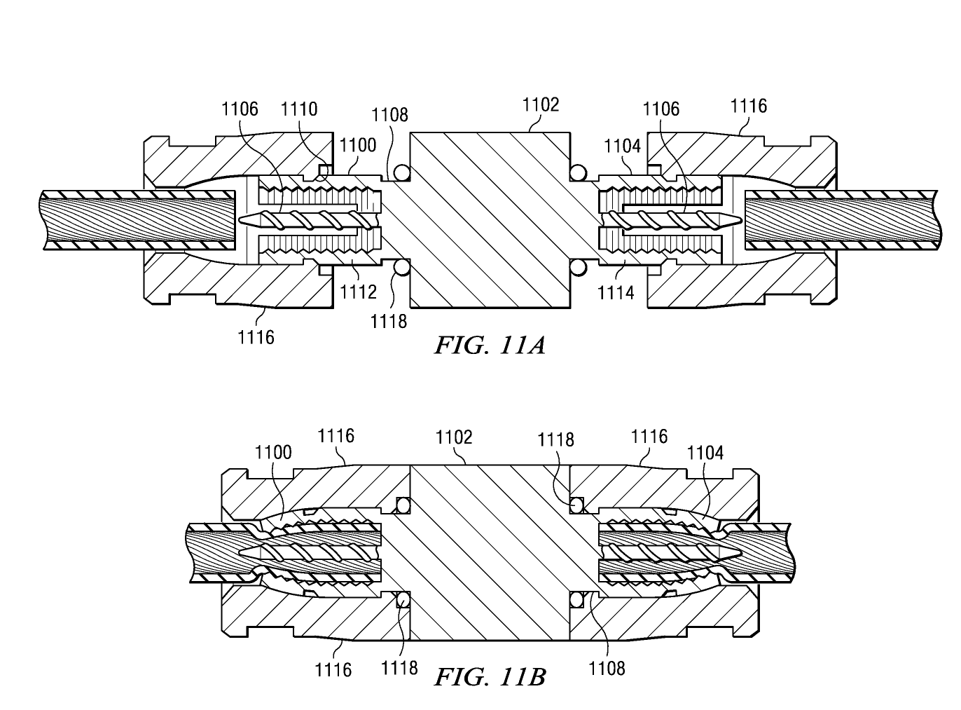

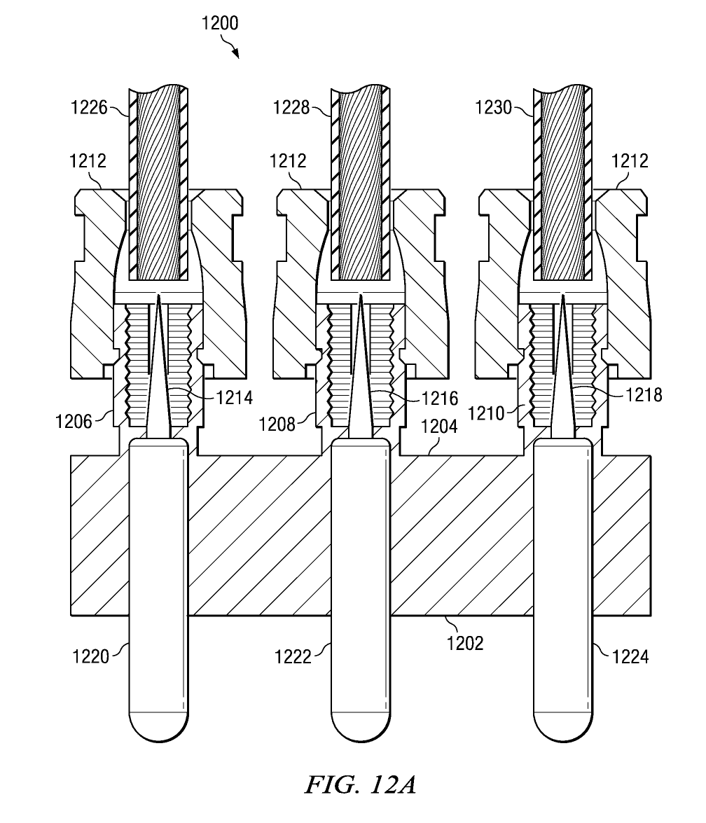

FIGS. 11A and 11B illustrate an inline splice embodiment of this connector. A first slitted tube 1100 extends in one axial direction from a body 1102 while a second slitted tube 1104 extends in an opposite axial direction. Each slitted tube 1100, 1104 has a center pin 1106, axially inward and outward grooves 1108, 1110 on its external surface 1112, and an inner surface 1114 which may be roughened, knurled or threaded. Each such tube 1100, 1104 is provided with a separate cap 1116 which in form and operation is similar to cap 1030 of FIGS. 10A-10B. For each axially inward groove 1108, a compressible O-ring 1118 may be provided which compresses upon the advancement of cap 1116 axially inwardly on tube 1100 or 1104.

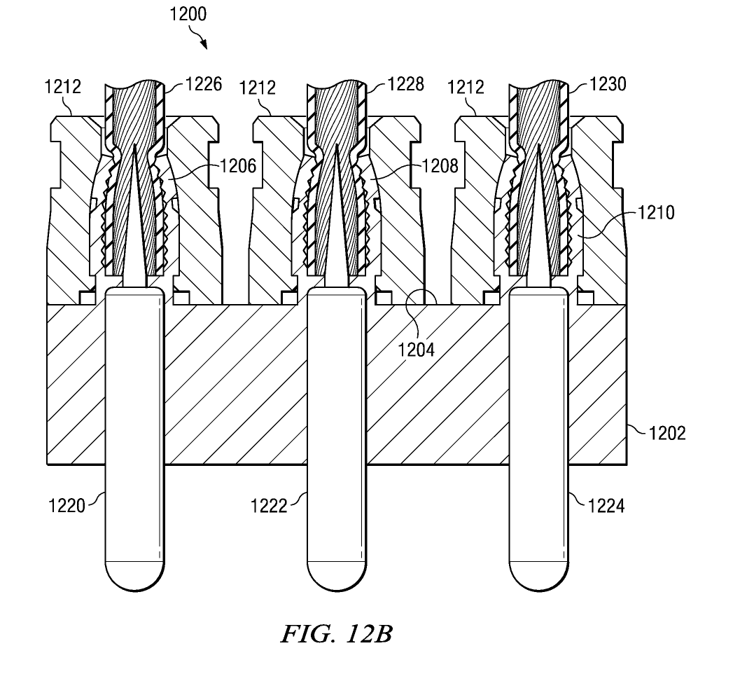

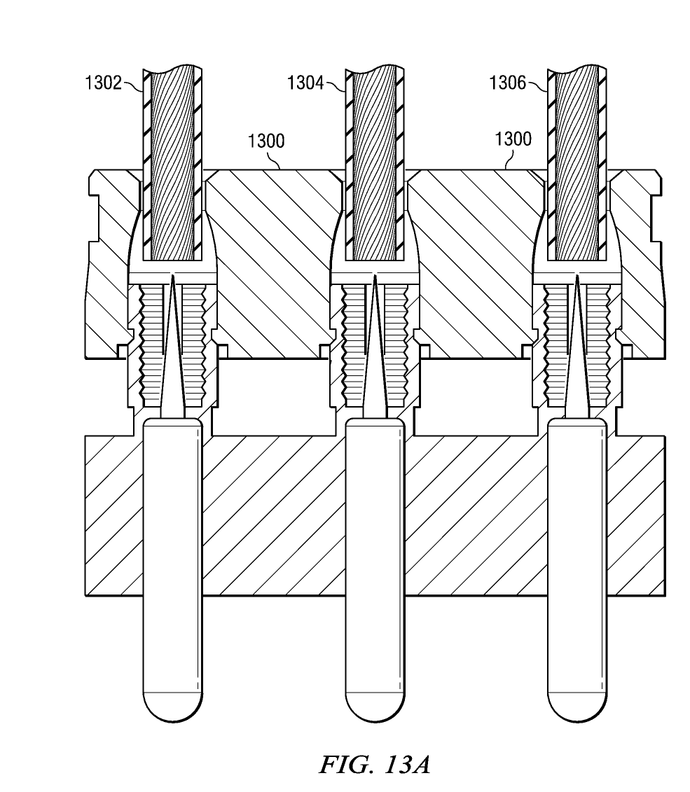

FIGS. 12A and 12B show a similar embodiment 1200 in which a unitary connector body 1202 has a flat base surface or land 1204 from which a plurality of tubes 1206, 1208, 1210 project in parallel in one direction. Each slitted tube 1206, 1208, 1210 is similar in its construction and function to tube 1010 of FIGS. 10A-10C. For each such tube 1206-1210, there is provided a respective cap 1212 similar in construction and function to cap 1030 of FIGS. 10A and 10B. The body 1202 can be formed of an insulator and has inserted or in-molded therein conductive elements 1214, 1216, 1218, respectively centered on the axes of tubes 1206-1210 and terminating inside tubes 1206-1210 with respective conical connection elements 1220, 1222, 1224. The conical elements could be replaced with other sorts of center pins. In this embodiment, twisting each insulated conductor 1226-1230 onto a center pin is not preferred, because in all likelihood the conductors 1226-1230 are parallel conductors of a wiring harness. FIG. 12A shows this parallel connector in an initial assembly position, in which independent caps 1212 have not been advanced onto base 1204, and FIG. 12B shows the connector 1200 in a final assembly position.

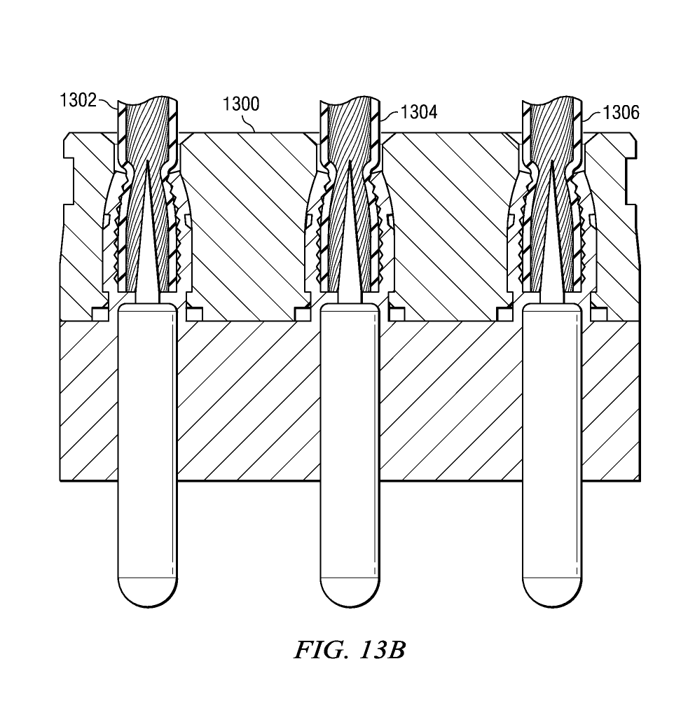

FIGS. 13A and 13B show an embodiment similar to the one shown in FIGS. 12A and 12B, but instead of independent caps 1212 there is provided a single multiconductor cap 1300, which completes the connection to multiple conductors 1302-1306 all at the same time.

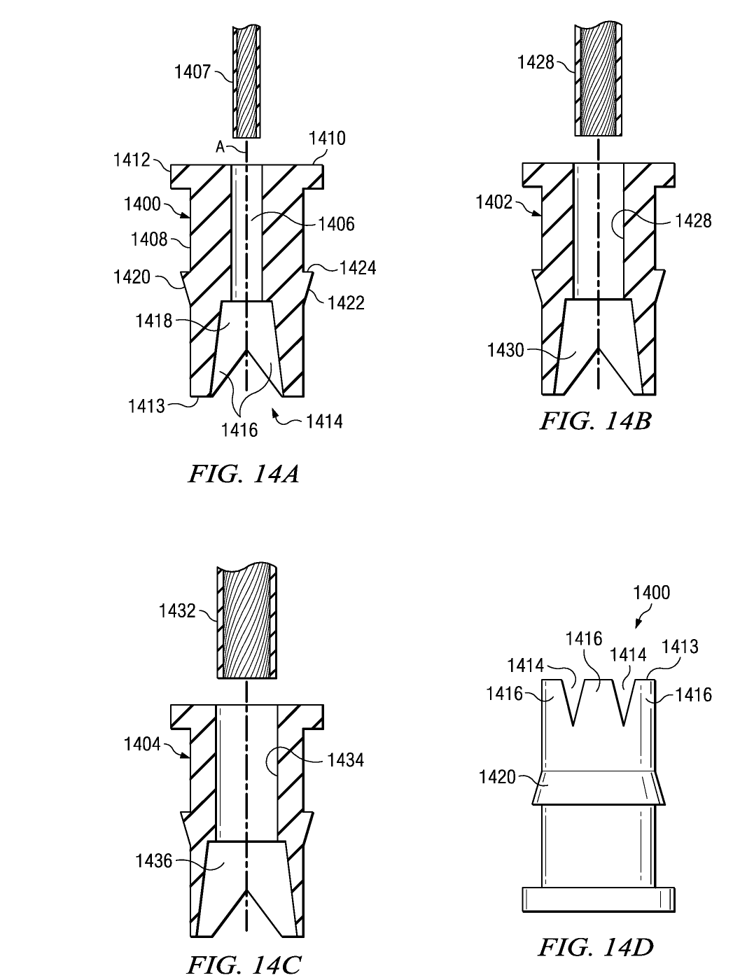

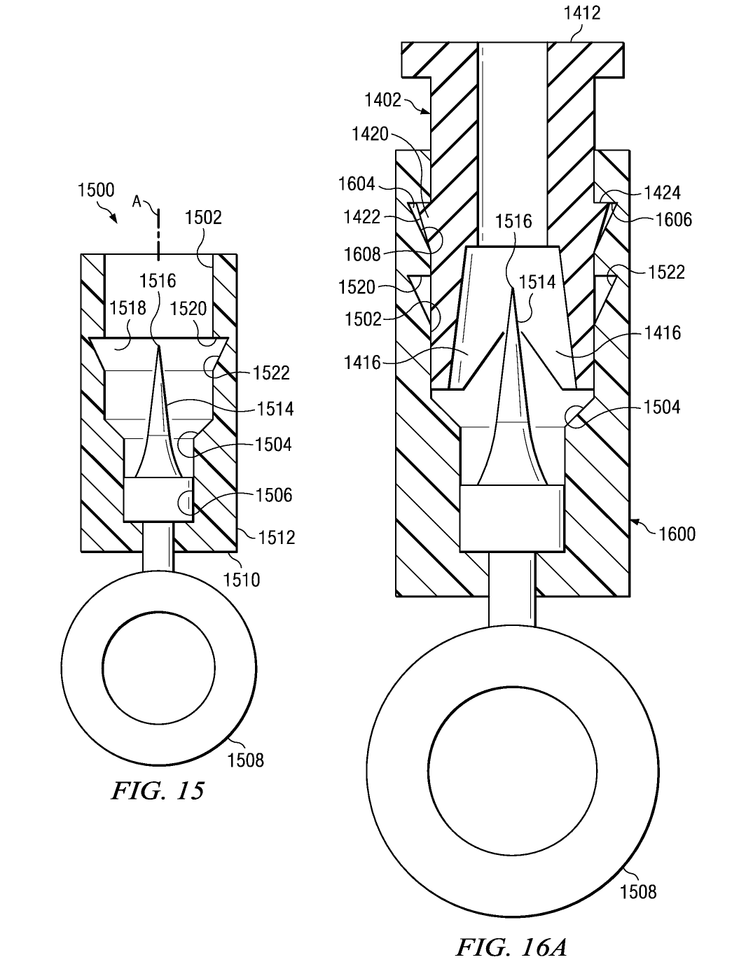

A different embodiment of the invention is depicted in FIGS. 14A-16B. FIG. 15 is an axial sectional view of a single-snap female connector body 1500 having a substantially cylindrical bore 1502. The bore 1502 terminates at its inner axial end with a beveled or sloped surface 1504. The surface 1504 can be straight in this section, as shown, or could be curved. An axial inner end of the surface 1504 is joined to a bore 1506 of smaller diameter. A conductive element 1508 extends through a back wall 1510 of the connector body 1512. Body 1512 can for example be injection-molded of plastic. The conductive element in the illustrated embodiment is an annular connector element for a screw connection or the like, but could as easily be a pin, banana plug, spade or other common connector shape.

The connector element 1508 extends axially outwardly into bore 1502 and terminates in a center pin 1514 which, in the illustrated embodiment, has a curved cross section an ends in a sharp tip 1516. Tip 1516 is designed to impale an end of an insulated conductor.

The bore 1502 has along its length a groove 1518 which, like other embodiments disclosed herein, is formed of a differential surface pair such that a leading surface 1520 thereof has a smaller surface area than a trailing surface 1522. In the illustrated embodiment, surface 1520 is at right angles to an axis A of body 1500 while surface 1522 is frustoconical.

Any one of a plurality of caps 1400, 1402, 1404 (see FIGS. 14A-14C) can be inserted into the bore 1502 of connector 1500. Taking cap 1400 as an example, there is provided an axial bore 1406 sized to closely receive a conductor 1407 of a specific size or range of sizes. An outer surface 1408 of cap 1400 is substantially cylindrical in form (using the broad mathematical definition of cylinder; both curved and polygonal axial cross sections are contemplated). An axially outer end 1410 of the cap 1400 can be provided with an enlargement 1412 so as to receive a jaw of a compression tool (not shown).

An inner axial end 1413 of the cap 1400 has a plurality of V-shaped slits 1414 formed therein (see also FIG. 14D) such that a large portion of the cross sectional area of the cap 1400 has been removed at the axial location of end 1413. The remaining gores 1416, which preferably are four in number, are thus capable of being collapsed inwardly on axis A upon the application of sufficient force.

The inner bore 1406 terminates at an axially inner end thereof in an enlarged cavity 1418. The cavity 1418 creates an interior volume to accommodate the spread of the strands of conductor once the conductor 1407 has been impaled on center pin 1514.

A ridge 1420, which can be axially circumferential, is formed on the external cylindrical surface 1408 to radially outwardly extend therefrom. The ridge 1420 is preferably formed as a differential surface pair, where a leading edge 1422 has more surface area than a trailing edge 1424. The shape of ridge 1420 preferably conforms to the shape of groove 1518 of female connector body 1500 and also conforms to groove 1518 in axial position. The leading surface 1422 of ridge 1420 can be frustoconical, as shown, or could be a surface which is curved in axial section; the trailing surface 1424 in the illustrated embodiment is annular and is at right angles to axis A of the cap 1400, but could take another form.

Caps 1402 and 1404 are identical to cap 1400 except for two variations. The cap 1402 has an internal bore 1426 which is larger than bore 1406, as it is designed to closely receive a conductor 1428 that has a larger diameter. An ending cavity 1430 is also larger than end cavity 1418, as more strands of conductor will have to be accommodated once the conductor 1428 is impaled on center pin 1514. Cavities 1418 and 1430 take a reverse frustoconical shape in the instance that center pin 1514 has an increasing cross sectional area as one proceeds axially inwardly. The cavities 1418 and 1430 would be formed as straight cylinders if center pin 1514 took a straight cylindrical shape.

The cap 1404 is designed to receive a conductor 1432 of even larger diameter. Hence, it has a larger bore 1434 that is slightly larger in diameter than conductor 1432, and a larger end cavity 1436 that can accommodate a larger volume of conductive strands.

The caps 1400-1404 in one embodiment could be furnished in a kit with one of the female connector bodies 1500 or 1600 (the latter of which is described below). In this embodiment, the user would, as a first step in using the connector, select one of the caps 1400-1404 for the size of conductor 1407, 1426, 1432 to be connected. This cap would then be threaded onto the conductor 1407, 1426, 1432 prior to the connection of the cap and conductor to the female connector body 1500 or 1600.

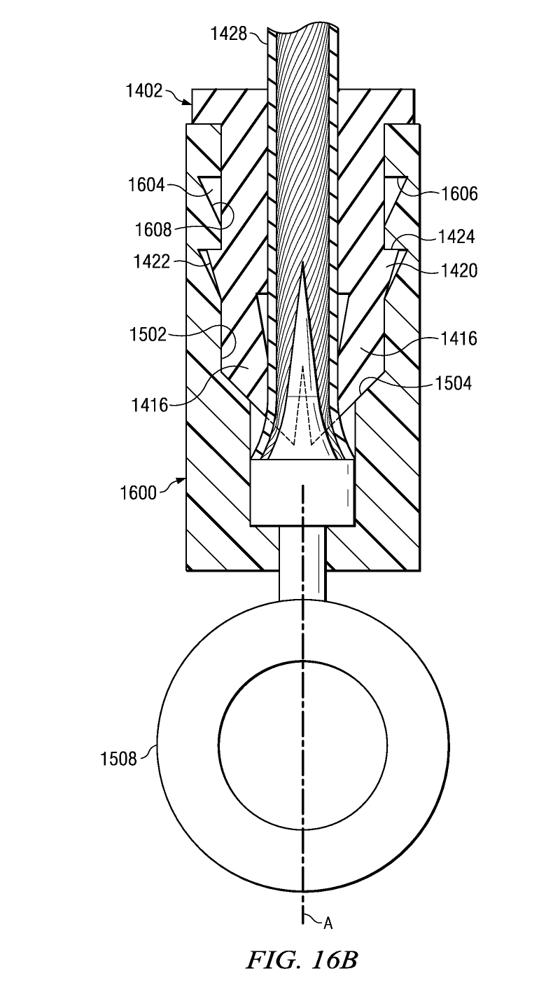

A double-snap connector body 1600 is shown in FIGS. 16A and 16B. Connector body 1600 is in general similar in dimension and constitution to connector 1500, and hence like characters identify like parts. A bore 1602 can even be the same length as bore 1502 of the connector body 1500. The only difference is that the bore 1602 is provide with a second, axially outward groove 1604 which can be formed by a differential surface pair 1606, 1608, similar in form to surface pair 1520, 1522.

In an embodiment alternative to providing multiple caps 1400-1404 (three are shown, but the number is exemplary only), a cap (such as cap 1402) can be pre-inserted into the two-snap female connector body 1600 prior to sale to the user. In this condition, the ridge 1420 would occupy the axially outward groove 1604.

In using the embodiment shown in FIGS. 16A-16B, the user takes the end of a multistranded conductor and passes it through the cap 1402, into bore 1502 and onto pin 1514, such the strands of the conductor (for cap 1402, this would be conductor 1428) are spread by the pin 1514. The cap 1402 is advanced, as by application of a tool to land 1412 axially inwardly into bore 1502. When this happens the gores 1416 of the cap 1402 encounter the beveled or sloped surface 1504 of the bore 1502, and begin to inwardly collapse on the axis A of the connector. This tightly grips the conductor. After sufficient advance the ridge 1420 of the cap 1402 snaps into axially inward groove 1518, firmly completing the connection. The V-shaped slits 1414 made in the end 1413 of the cap permit the axial collapse of gores 1416.

In the embodiment shown in FIG. 15, the user selects one of caps 1400-1404 and threads it onto a respective one of the conductors 1407, 1428, 1432. The conductor is then impaled onto pin 1514. Thereafter, the cap 1400, 1402 or 1404 is advanced down bore 1502, as by means of a compression tool, until ridge 1420 registers with the groove 1518. By the time this happens, the gores 1416 will have encountered sloped surface 1504 and will have collapsed on the conductor, firmly affixing it in place.

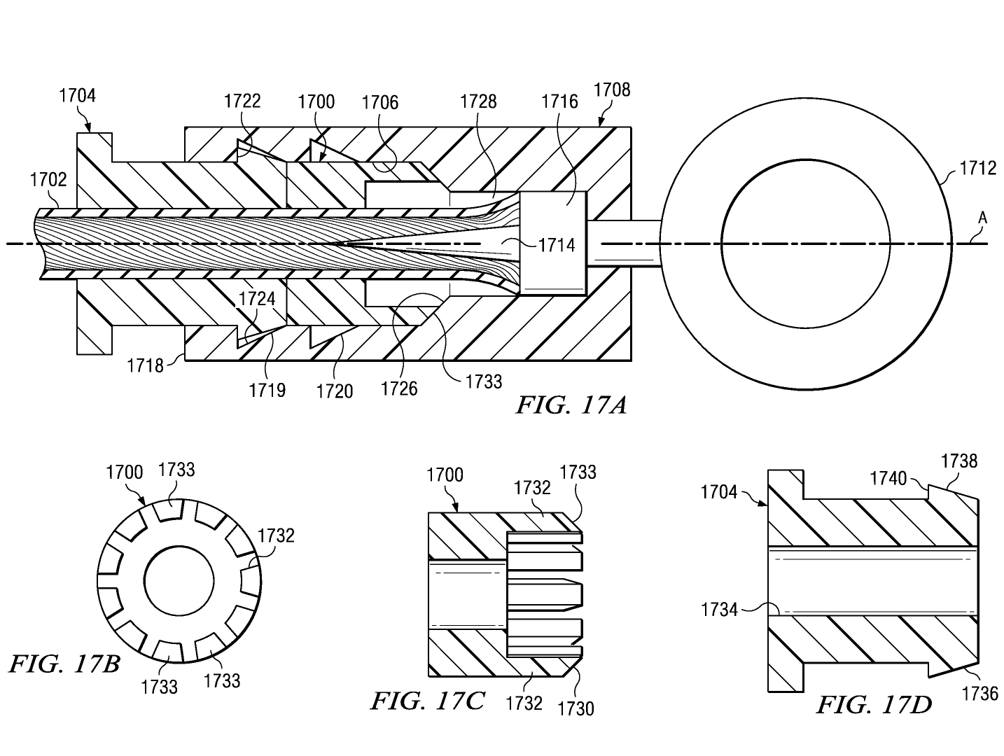

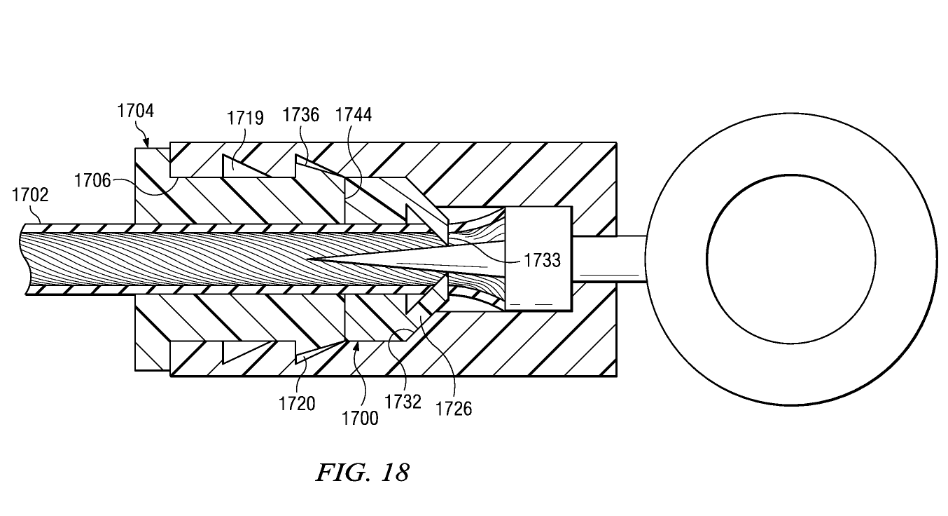

In the embodiments shown in FIGS. 17A-19B, a collar 1700 is provided as an additional component. Referring particularly to FIGS. 17A-18, the collar 1700 performs the function of firmly fastening the multistranded conductor 1702, while a cap 1704 acts as a “pusher” to advance the collar 1700 from an initial position inside a bore 1706 of a female connector body 1708 to a final position therein.

The connector body 1708 has a conductive element 1710, one end 1712 of which can be an annulus but which can also be formed as a spade, pin, banana plug or the like. The other end of the conductive element is a center pin 1714 which axially outwardly extends into the body bore 1706 from a base 1716 thereof. The center pin 1714 can be conical, as shown, or can take other convenient shapes such as others illustrated in this specification for other embodiments.

The female connector body has an outer axial end 1718 on which bore 1706 opens. The bore 1706 is provide with first and second preferably circumferential grooves 1719, 1720 which are axially displaced from one another. It is preferred that each groove 1718, 1720 be formed by a differential surface pair. By way of example, the axially outward groove 1719 has a leading surface 1722 with a relatively small surface area, and can take the form of an annulus or step at right angles to an axis A of the connector. A trailing surface 1724 of the groove 1719 has a relatively large surface area in comparison to leading surface 1722, and can be frustoconical in shape.

At a position which is axially inwardly displaced from the grooves 1719, 1720, the bore 1706 has a surface 1726 which slopes radially and axially inwardly. Surface 1726 can be frustoconical or frustopyramidal, and can have a straight profile in axial section, as shown, or can take a curved profile. The bore 1706 finishes in a section 1728 of much smaller cross section than its remainder.

The collar 1700 preferably has a cylindrical bore that permits the introduction therethrough of the conductor 1702. Collar 1700 will in general have diameter which is a little smaller than the diameter of the bore 1706. A front end 1730 of the collar 1700 is divided into a plurality of axially extending fingers 1732 which initially are spaced apart from each other. It is preferred that each finger 1732 terminate in a radially inwardly beveled edge 1733. The collar 1700 precedes the cap 1704 inside the female connector body bore 1706.

The last component of this embodiment is the cap 1704, which has an internal bore 1734 that permits the threading of the conductor 1702 therethrough. The cap 1704 has a generally cylindrical outer surface with a ridge 1736 thereon which extends radially outwardly from the generally cylindrical outer surface. Preferably, the ridge 1736 is formed with a differential surface pair: a leading surface 1738 has more surface area than a trailing surface 1740. Surface 1740 can be formed as an axially orthogonal annulus, as shown, while leading surface 1738 can be frustoconical. An outer axial end 1742 can be enlarged so as to receive a compression tool.

A first stage of conductor-connector assembly is shown in FIG. 17A. The user has threaded the cap 1704 and then the collar 1700 onto the free end of a conductor 1702 to be connected. Next, the user inserts the conductor 1702 into the bore 1706 of the connector body 1708 and impales the conductor 1702 onto the center pin 1714. The user then inserts the collar 1702 into the bore 1706 until resistance is encountered and snaps the cap 1704 into a first position, in which the ridge 1736 thereof is in registration with axially outward groove 1719. Alternatively, the connector body 1708 can come to the user in a condition in which, preassembled to it, are collar 1700 and cap 1704 in a first, axially outward position as shown.

A second, final stage of assembly is shown in FIG. 18. The cap 1704 is advanced into bore 1706 such that ridge 1736 leaves groove 1719 and comes instead into registration with groove 1720. A front end 1744 of the cap 1704 pushes the collar 1700 axially inwardly. As this happens, beveled surfaces 1733 of collar fingers 1732 begin to cam inwardly on sloped surface 1726 of bore 1706, forcing the fingers inwardly into contact with conductor 1702. The fingers 1732 can be designed to be long and can be sharpened, so as to intentionally pierce the insulation as shown, or they can instead be shorter and blunter so as to only the grip the insulated external surface of the conductor 1702. The fingers 1732 will in any event firmly affix the conductive strands of the conductor 1702 to the center pin 1714.

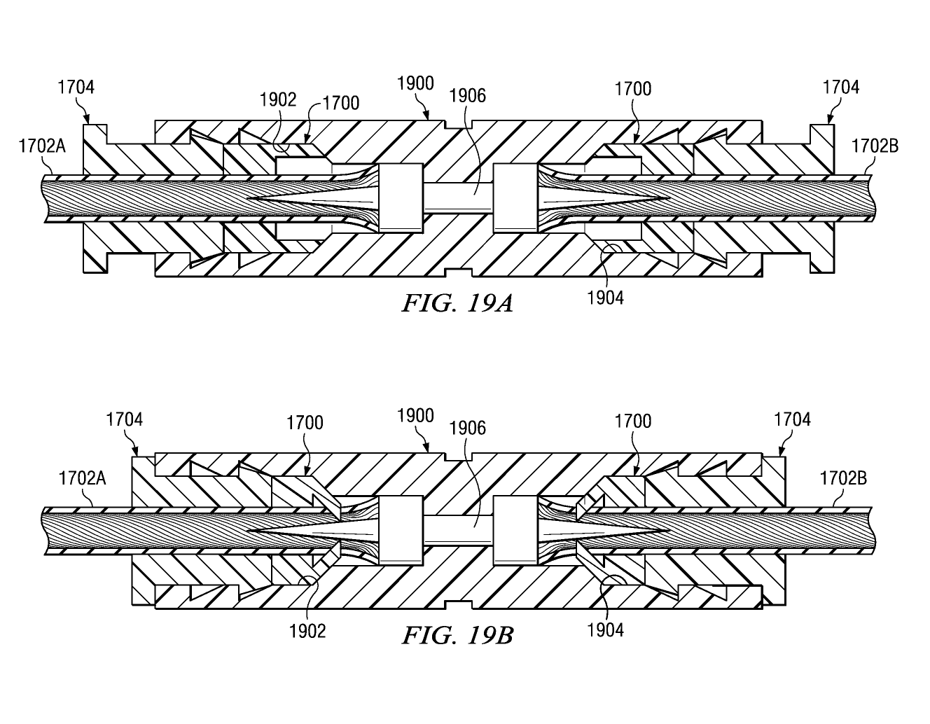

FIGS. 19A-19B illustrate a variation on the embodiment shown in FIGS. 17A-18, in the form of an in line-connector. A body 1900 has two bores 1902, 1904, each similar to bore 1706. A center pin 1906 extends from bore 1902 to bore 1904 so as to provide conductive connection therebetween. Each bore 1902, 1904 is provided with a cap 1700 and a collar 1704, the structure and function of which are the same as in the embodiments described in FIGS. 17A-18. FIG. 19A illustrates an initial stage in the in-line connection of conductor 1702A to a conductor 1702B, while FIG. 19B illustrates a final stage thereof.

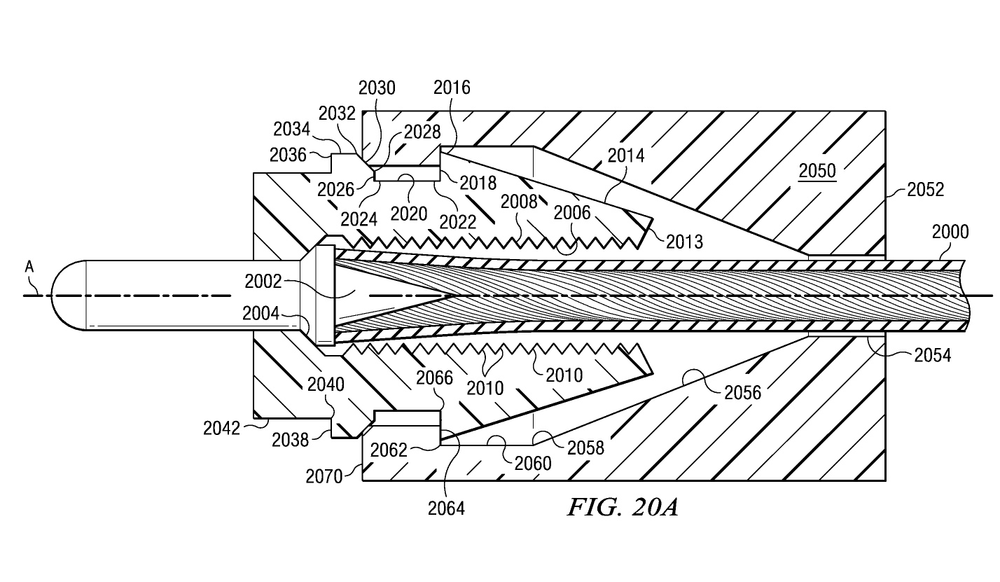

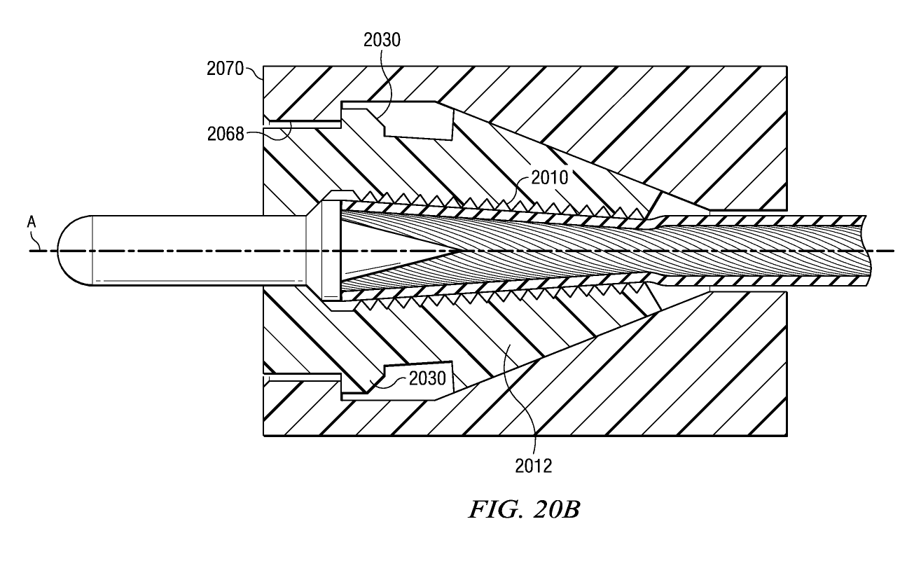

In the embodiment shown in FIG. 20A, a preferably insulated conductor 2000 has been inserted onto a conical center pin 2002. The center pin 2002 extends axially outwardly from the base 2004 of a bore 2006, a substantially cylindrical sidewall 2008 of which has been provided with threads, knurls or other friction-providing surfaces 2010. However, as uncompressed, the internal diameter of the bore 2006 does not prevent the insertion of the conductor 2000 all of the way on to the center pin 2002.

The bore 2006 is formed in a female connector body 2012. An external outer surface of body 2012 preferably has at least four zones. At an axially outward end 2013 there appears a first sloped surface 2014, which has a small diameter at end 2013 but which has a larger diameter at the inward end 2016 of the surface 2014. The surface 2014 can be straight in axial cross section as shown, or can be convexly or concavely curved, as has been explained in conjunction with other embodiments herein. At point 2016 there begins a first step surface 2018, which as illustrated can be annular and can be at right angles to the axis A.

The step surface 2018 proceeds radially inwardly for a short distance until it meets surface or land 2020. The surface 2020 is substantially cylindrical and can have a uniform diameter from its outer axial end 2022 to an inner axial end 2024 thereof.

A second step surface 2026 proceeds axially outwardly from point 2024 to a point 2028. At point 2028, a beveled or sloped surface 2030 starts and proceeds radially outwardly and axially inwardly to point 2032. Surface 2030 may for example be frustoconical and, in an alternative embodiment, can begin at point 2024, such that step surface 2026 is omitted.

A further cylindrical surface 2034, at a uniform diameter, extends axially inwardly from point 2032 to a point 2036. A radially inwardly extending step surface 2038 extends from point 2036 to a point 2040. A cylindrical land 2042 extends axially inwardly from point 2040 for at least a substantial distance.

The body 2012 is used in connection with a cap 2050. At its outer axial end 2052, a central bore 2054 is provided to accept therethrough the conductor to be connected. At a point axially inward from the end 2052, a sloped surface 2056 begins. This sloped surface extends axially inwardly and radially outwardly to a point 2058. The length of the surface 2056 should be at least as long as the length of body surface 2014. When the diameter of point 2016 is reached, the cap sloped surface 2056 may end and the internal cavity of cap may start to be defined by a cylindrical surface 2060.

The cylindrical surface 2060 proceeds axially inwardly until a point 2062, at which a step surface 2064 extends radially inwardly to a point 2066. A ridge 2068 begins at point 2066 and extends axially inwardly therefrom until an inner end 2070 of the cap 2050 is reached.

In a first stage of assembly of the conductor 2000 to this connector, the step surface 2064 abuts the body surface 2018, and the corner or end 2070 of the cap rides on the beveled surface 2030. The user then pushes the cap 2050 axially inwardly until the configuration shown in FIG. 20B is reached. When this happens, sloped surface 2056 starts camming against connector body surface 2014, eventually compressing the frictional elements 2010 of bore 2008 into the insulation of conductor 2000. While this is happening, the ridge 2068 of cap 2050 rides over the beveled surface 2030 and surface 2034, to snap past body step surface 2038.

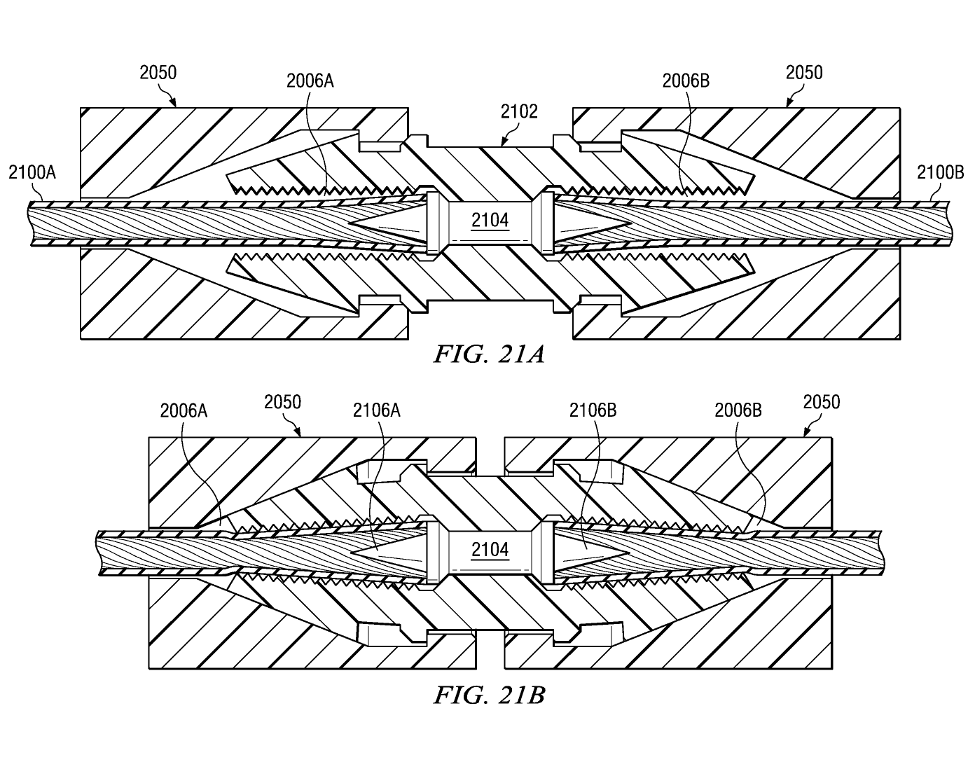

FIGS. 21A and 21B show first and second stages of assembly of one conductor 2100A in line to another conductor 2100B. Two bores 2006A and 2006B are formed in a unitary body 2102, and these are otherwise identical in structure and function to bore 2006 in the embodiment shown in FIGS. 20A and 20B. A unitary pin 2104 has opposed conical ends 2106A and 2106B. A cap 2050 is provided for each bore 2006A, B and their construction and function are the same as that for cap 2050 in FIGS. 20A and 20B.

It should be understood that various features and modifications shown in only one or some of the illustrated embodiments can be easily adapted to the others. Any of the illustrated embodiments can take on a prismatic rather than a cylindrical form, and can even have irregular but substantially axially uniform cross-sections. Any of the illustrated connectors may be formed all of metal or alternatively may be largely constituted by injection-molded plastic. Most of the embodiments are suitable for connecting to uninsulated as well as insulated multistranded wire. All can be furnished in a preassembled condition to end users, or alternatively can be furnished with a cap and physically separate connector body. The connectors according to the invention may be furnished singly or multiply, and may be joined together as might occur where a terminal block or wiring harness has several connector body bores.

O-rings may be furnished in any of the embodiments for sealing an axially outward cap end to the connector body, and/or for sealing the inner bore of the cap to the insulation of the conductor. All illustrated connector bodies may be furnished with only one, or more than two, detenting grooves. All embodiments may be manufactured in end-to-end or Y-conductor splicing forms. The described detenting grooves and ridges can be formed by surfaces other than annuluses and frustoconical surfaces. Connectors may be provided according to the invention in which a groove is provided on the cap and one, two or more detenting ridges are provided on the sidewall of the connector body bore, in mirror image to those described. All embodiments may be provided with discontinuous instead of endless grooves and ridges, and these grooves and ridges may even include several, physically separate segments at each axial position. The conductor supplied with the connector(s) may have its insulation marked along its length to indicate a correct amount of insertion into the connector. These modifications are all within the scope of the disclosed invention.

In summary, different embodiments of a compression snap electrical connector have been shown and described, wherein preferably a ridge or groove on a cap registers with one of at least two grooves or ridges formed in the bore of the connector body. While illustrated embodiments of the present invention have been described and illustrated in the appended drawings, the present invention is not limited thereto but only by the scope and spirit of the appended claims.

I claim:

1. An electrical connector, comprising:
a connector body having a bore with an axis and an open end having a first internal diameter, the bore having a sidewall extending generally axially inwardly from the open end to an inner end of the bore, a radially inwardly and axially inwardly sloping surface extending from the inner end of the bore;
at least one groove formed in the sidewall, the first groove disposed to be spaced axially inwardly from the open end of the bore, the first groove generally having a diameter which is greater than the first internal diameter;
said at least one groove having a first surface and a second surface formed axially outwardly from the first surface, the first and second surfaces formed to be generally at an angle to the axis, an area of the first surface being substantially greater than an area of the second surface; and
a cap having an inner axial end and an outer axial end and having a cavity from the inner to the outer axial ends for accepting an insulated conductor therethrough, an outer surface of the cap including a general outer surface substantially parallel to the axis and a ridge generally extending radially outwardly therefrom, the ridge having a leading surface and a trailing surface formed axially outwardly from the leading surface, an area of the leading surface being substantially greater than an area of the trailing surface;
the ridge of the cap adapted to fit into said at least one groove of the connector body bore;
an inner end of the cap terminating in a plurality of spaced-apart gores, the gores, when the cap is advanced into the bore of the connector body, camming against said sloping surface of the bore so as to radially inwardly collapse toward an axis of the connector body, the gores then grasping an external surface of a conductor, the cap meanwhile advanced to said at least one groove inwardly down the bore of the connector body so as to seat the leading surface of the ridge with the first surface of said at least one groove in order to in order to electrically connect to a conductive core of the insulated conductor.

2. The electrical connector of claim 1, wherein at least one of the first surfaces of the grooves and the leading surface of the cap is a beveled surface.

3. The electrical connector of claim 1, wherein the first and second grooves are endless.

4. The electrical connector of claim 1, wherein at least one of the second surfaces of the grooves and the trailing surface of the cap is formed to be substantially orthogonal to the axis.

5. The electrical connector of claim 1, wherein the ridge of the cap is endless.

6. The electrical connector of claim 1, wherein the sidewall of the bore of the connector body is generally cylindrical.

7. An electrical connector for connecting to a conductor, comprising:
a connector body having a bore with an open end and a bottom, a center pin extending axially outwardly from the bottom into the bore;
the bore having a general inner diameter and first and second grooves having a diameter greater than the general inner diameter, the first groove formed at a first, axially outward location in the bore, the second groove formed at a second, axially inward location in the bore to be displaced from the first groove;
a sloping surface formed in the bore to be axially inward from the grooves, the sloping surface extending radially and axially inwardly from the general inner diameter toward the bore bottom;
a collar having a bore for accepting the conductor therethrough, an axial inner end and an axial outer end, a plurality of spaced-apart fingers forming the last said inner end, the collar sized to fit within the general inner diameter of the body bore;
a cap having an inner axial end and an outer axial end, the cap having an general external diameter which is smaller than the general inner diameter of the bore body, at least one ridge formed on an outer surface of the cap to have a diameter greater than the general inner diameter of the bore body, said at least one ridge of the cap receivable into either the first or the second groove of the connector body;
the conductor impaled on the center pin, the cap advancing axially inwardly in said body bore so that the ridge thereof registers with the second groove, the cap pushing the collar axially inwardly such that the fingers of the collar cam against said sloping surface of the bore, said fingers then grasping an external surface of the conductor to affix the connector to the conductor.
